(19) United States
(12) Patent Application Publication
(10) Pub. No.: US 2025/0030843 A1
(43) Pub. Date: Jan. 23, 2025

(54) VIDEO CODING METHOD AND STORAGE MEDIUM

(71) Applicant: GUANGDONG OPPO MOBILE TELECOMMUNICATIONS CORP., LTD., Dongguan (CN)

(72) Inventor: Zhihuang XIE, Dongguan (CN)

(21) Appl. No.: 18/908,726

(22) Filed: Oct. 7, 2024

Related U.S. Application Data
(63) Continuation of application No. PCT/CN2022/086725, filed on Apr. 13, 2022.

(51) Int. Cl. H04N 19/105; H04N 19/176; H04N 19/61

(52) U.S. Cl. CPC H04N 19/105; H04N 19/176; H04N 19/61

(57) ABSTRACT

A video coding method and a storage medium are provided. A determined reconstructed sample mode for a current block can be one of a top reconstructed sample mode, a left reconstructed sample mode, or a top-and-left reconstructed sample mode. As such, based on an accurate reconstructed sample mode, a neighbouring reconstructed sample of the current block and a neighbouring reconstructed sample of a reference block can be determined more accurately, then a linear transform parameter is determined based on the neighbouring reconstructed sample of the current block and the neighbouring reconstructed sample of the reference block that are determined accurately, and linear transformation is performed on a first prediction value of the current block according to the linear transform parameter to obtain an accurate second prediction value.

### CROSS-REFERENCE TO RELATED APPLICATION(S)

This application is a continuation of International Application No. PCT/CN2022/086725, filed Apr. 13, 2022, the entire disclosure of which is incorporated herein by reference.

### TECHNICAL FIELD

The disclosure relates to the field of video coding technology, and more particularly, to a video coding method and apparatus, a device, a system, and a storage medium.

### BACKGROUND

Digital video technology can be applied to various video apparatuses, such as digital televisions, smart phones, computers, electronic readers, or video players, etc. With development of video technology, the data amount in video data is large. In order to facilitate transmission of video data, the video apparatus implements video compression technology, so that video data can be transmitted or stored more efficiently.

During video compression, data redundancy is reduced through prediction. Different pictures have significant or slight change in some specific scenarios. In some embodiments, in order to improve compression performance, illumination compensation can be performed on an obtained prediction value, so as to fit illumination change between a current picture and a reference picture, thereby reducing redundancy.

However, the existing illumination compensation technology is poor in effect.

### SUMMARY

In a first aspect, a video decoding method is provided in the disclosure. The method includes the following. A bitstream is decoded, and prediction is performed on a current block to obtain a first prediction value. A reconstructed sample mode for the current block is determined, where the reconstructed sample mode is one of N candidate modes, and the N candidate modes include at least one of a top reconstructed sample mode, a left reconstructed sample mode, or a top-and-left reconstructed sample mode. A neighbouring reconstructed sample of the current block and a neighbouring reconstructed sample of a reference block are determined according to the reconstructed sample mode for the current block. A linear transform parameter is determined according to the neighbouring reconstructed sample of the current block and the neighbouring reconstructed sample of the reference block, and linear transformation is performed on the first prediction value according to the linear transform parameter to obtain a second prediction value of the current block.

In a second aspect, a video encoding method is provided in embodiments of the disclosure. The method includes the following. Prediction is performed on a current block to obtain a first prediction value of the current block. A reconstructed sample mode for the current block is determined, where the reconstructed sample mode is one of N candidate modes, and the N candidate modes include at least one of a top reconstructed sample mode, a left reconstructed sample mode, or a top-and-left reconstructed sample mode. A second prediction value of the current block is determined according to the reconstructed sample mode for the current block, where the second prediction value is obtained by performing illumination compensation on the first prediction value based on the reconstructed sample mode for the current block.

In a third aspect, a non-transitory computer storage medium storing a bitstream generated according to an encoding method, wherein the encoding method includes: performing prediction on a current block to obtain a first prediction value of the current block; determining a reconstructed sample mode for the current block, wherein the reconstructed sample mode is one of N candidate modes, and the N candidate modes comprise at least one of a top reconstructed sample mode, a left reconstructed sample mode, or a top-and-left reconstructed sample mode; determining a second prediction value of the current block according to the reconstructed sample mode for the current block, wherein the second prediction value is obtained by performing illumination compensation on the first prediction value based on the reconstructed sample mode for the current block.

### BRIEF DESCRIPTION OF THE DRAWINGS

FIG. 1 is a schematic block diagram of a video coding system according to embodiments of the disclosure.

FIG. 2 is a schematic block diagram of a video encoder provided in embodiments of the disclosure.

FIG. 3 is a schematic block diagram of a decoding framework provided in embodiments of the disclosure.

FIG. 4A and FIG. 4B are schematic diagrams illustrating illumination on two pictures.

FIG. 5 is a schematic diagram illustrating principles of an illumination compensation technology according to embodiments of the disclosure.

FIG. 6 is an exemplary diagram illustrating reconstructed samples according to embodiments of the disclosure.

FIG. 7 is a schematic flowchart of a video decoding method provided in embodiments of the disclosure.

FIG. 8A and FIG. 8B are exemplary diagrams illustrating left neighbouring samples according to embodiments of the disclosure.

FIG. 9A and FIG. 9B are exemplary diagrams illustrating top neighbouring samples according to embodiments of the disclosure.

FIG. 10 is a schematic flowchart of a video encoding method provided in embodiments of the disclosure.

FIG. 11 is a schematic block diagram of a video decoding apparatus provided in embodiments of the disclosure.

FIG. 12 is a schematic block diagram of a video encoding apparatus provided in embodiments of the disclosure.

FIG. 13 is a schematic block diagram of an electronic device provided in embodiments of the disclosure.

FIG. 14 is a schematic block diagram of a video coding system provided in embodiments of the disclosure.

### DETAILED DESCRIPTION

Technical solutions of embodiments of the disclosure will be described below with reference to the accompanying drawings in embodiments of the disclosure.

The disclosure can be applied to the field of picture coding, video coding, hardware video coding, dedicated circuit video coding, real-time video coding, etc. Alternatively, the solutions of the disclosure can be applied to other proprietary or industry standards, including telecommunication standardization sector of international telecommunication union (ITU-T) H.261, international organization for standardization (ISO)/international electrotechnical commission (IEC) moving picture experts group (MPEG)-1Visual, ITU-TH.262 or ISO/IECMPEG-2Visual, ITU-TH.263, ISO/IECMPEG-4Visual, ITU-TH.264 (also known as ISO/IECMPEG-4AVC), including scalable video coding (SVC) and multi-view video coding (MVC) extensions. It should be understood that, the techniques in the disclosure are not limited to any particular coding standard or technology.

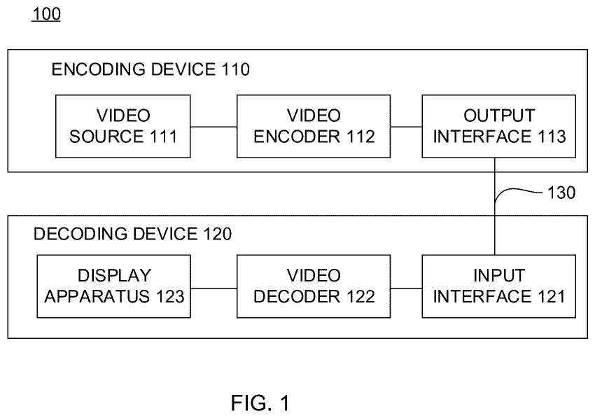

To facilitate understanding, a video coding system according to embodiments of the disclosure is firstly described with reference to FIG. 1.

FIG. 1 is a schematic block diagram of a video coding system according to embodiments of the disclosure. It should be noted that, FIG. 1 is only an example, and the video coding system in embodiments of the disclosure includes but is not limited to that illustrated in FIG. 1. As illustrated in FIG. 1, the video coding system 100 includes an encoding device 110 and a decoding device 120. The encoding device is configured to encode (which can be understood as compress) video data to generate a bitstream, and transmit the bitstream to the decoding device. The decoding device is configured to decode the bitstream generated by the encoding device to obtain decoded video data.

The encoding device 110 in embodiments of the disclosure can be understood as a device having a video encoding function, and the decoding device 120 can be understood as a device having a video decoding function, that is, the encoding device 110 and the decoding device 120 in embodiments of the disclosure include a wider range of devices, including smartphones, desktop computers, mobile computing devices, notebook (such as laptop) computers, tablet computers, set-top boxes, televisions, cameras, display apparatus, digital media players, video game consoles, vehicle-mounted computers, and the like.

In some embodiments, the encoding device 110 can transmit encoded video data (such as bitstream) to the decoding device 120 via a channel 130. The channel 130 can include one or more media and/or apparatuses capable of transmitting the encoded video data from the encoding device 110 to the decoding device 120.

In an example, the channel 130 includes one or more communication media that enable the encoding device 110 to transmit the encoded video data directly to the decoding device 120 in real time. In this example, the encoding device 110 can modulate the encoded video data according to a communication standard and transmit the modulated video data to the decoding device 120. The communication medium includes a wireless communication medium, such as a radio frequency spectrum. Optionally, the communication medium may also include a wired communication medium, such as one or more physical transmission lines.

In another example, the channel 130 includes a storage medium that can store video data encoded by the encoding device 110. The storage medium includes a variety of local access data storage media, such as optical discs, digital versatile discs (DVDs), flash memory, and the like. In this example, the decoding device 120 can obtain the encoded video data from the storage medium.

In another example, the channel 130 can include a storage server that can store video data encoded by the encoding device 110. In this example, the decoding device 120 can download the stored encoded video data from the storage server. Optionally, the storage server can store the encoded video data and can transmit the encoded video data to the decoding device 120. For example, the storage server can be a web server (e.g., for a website), a file transfer protocol (FTP) server, and the like.

In some embodiments, the encoding device 110 includes a video encoder 112 and an output interface 113. The output interface 113 can include a modulator/demodulator (modem) and/or a transmitter.

In some embodiments, the encoding device 110 can include a video source 111 in addition to the video encoder 112 and the output interface 113.

The video source 111 can include at least one of a video capture apparatus (for example, a video camera), a video archive, a video input interface, or a computer graphics system, where the video input interface is configured to receive video data from a video content provider, and the computer graphics system is configured to generate video data.

The video encoder 112 is configured to encode the video data from the video source 111 to generate a bitstream. The video data can include one or more pictures or a sequence of pictures. The bitstream contains encoding information of a picture or a sequence of pictures. The encoding information can include encoded picture data and associated data. The associated data can include a sequence parameter set (SPS), a picture parameter set (PPS), and other syntax structures. The SPS can contain parameters applied to one or more sequences. The PPS can contain parameters applied to one or more pictures. The syntax structure refers to a set of zero or multiple syntax elements arranged in a specified order in the bitstream.

The video encoder 112 directly transmits the encoded video data to the decoding device 120 via the output interface 113. The encoded video data can also be stored in a storage medium or a storage server for subsequent reading by the decoding device 120.

In some embodiments, the decoding device 120 includes an input interface 121 and a video decoder 122.

In some embodiments, the decoding device 120 can include a display apparatus 123 in addition to the input interface 121 and the video decoder 122.

The input interface 121 includes a receiver and/or a modem. The input interface 121 can receive encoded video data through the channel 130.

The video decoder 122 is configured to decode the encoded video data to obtain decoded video data, and transmit the decoded video data to the display apparatus 123.

The display apparatus 123 is configured to display the decoded video data. The display apparatus 123 can be integrated together with the decoding device 120 or external to the decoding device 120. The display apparatus 123 can include various display apparatuses, such as a liquid crystal display (LCD), a plasma display, an organic light emitting diode (OLED) display, or other types of display apparatuses.

In addition, FIG. 1 is only an example, and the technical solutions of embodiments of the disclosure are not limited to FIG. 1. For example, the technology of the disclosure can also be applied to single-sided video encoding or single-sided video decoding.

A video encoder in embodiments of the disclosure will be described below.

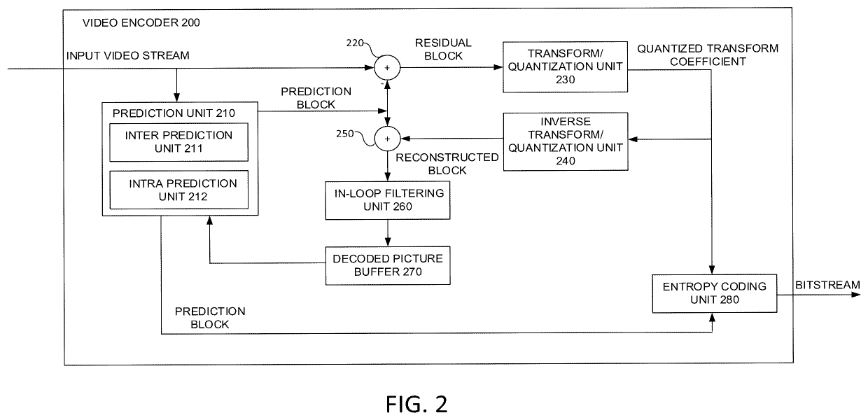

FIG. 2 is a schematic block diagram of a video encoder 200 provided in embodiments of the disclosure. It should be understood that, the video encoder 200 can be configured to perform lossy compression or lossless compression on a picture. The lossless compression can be visually lossless compression or mathematically lossless compression.

The video encoder 200 can be applied to picture data in luma-chroma (YCbCr, YUV) format. For example, a YUV ratio can be 4:2:0, 4:2:2, or 4:4:4, where Y represents luminance (Luma), Cb (U) represents blue chrominance, and Cr (V) represents red chrominance. U and V represent chrominance (Chroma) for describing colour and saturation. For example, in terms of color format, 4:2:0 represents that every 4 pixels have 4 luma components and 2 chroma components (YYYYCbCr), 4:2:2 represents that every 4 pixels have 4 luma components and 4 chroma components (YYYYCbCrCbCr), and 4:4:4 represents full pixel display (YYYYCbCrCbCrCbCrCbCr).

For example, the video encoder 200 reads video data, and for each picture in the video data, partitions the picture into several coding tree units (CTU). In some examples, the CTU can be called “tree block”, “largest coding unit” (LCU), or “coding tree block” (CTB). Each CTU can be associated with a pixel block of the same size as the CTU within the picture. Each pixel can correspond to one luminance (luma) sample and two chrominance (chroma) samples. Thus, each CTU can be associated with one luma sample block and two chroma sample blocks. The CTU can have a size of 128×128, 64×64, 32×32, and so on. The CTU can be further partitioned into several coding units (CUs) for encoding. The CU can be a rectangular block or a square block. The CU can be further partitioned into a prediction unit(s) (PU) and a transform unit(s) (TU), so that encoding, prediction, and transformation are separated, which is more conducive to flexibility in processing. In an example, the CTU is partitioned into CUs in a quadtree manner, and the CU is partitioned into TUs and PUs in a quadtree manner.

The video encoder and video decoder can support various PU sizes. Assuming that a size of a specific CU is 2N×2N, the video encoder and video decoder can support PUs of 2N×2N or N×N for intra prediction, and support symmetric PUs of 2N×2N, 2N×N, N×2N, N×N, or similar size for inter prediction; and the video encoder and video decoder can also support asymmetric PUs of 2N×nU, 2N×nD, nL×2N, or nR×2N for inter prediction.

In some embodiments, as illustrated in FIG. 2, the video encoder 200 can include a prediction unit 210, a residual unit 220, a transform/quantization unit 230, an inverse transform/quantization unit 240, a reconstruction unit 250, an in-loop filtering unit 260, a decoded picture buffer 270, and an entropy coding unit 280. It should be noted that, the video encoder 200 can include more, fewer, or different functional components.

Optionally, in the disclosure, a current block can be referred to as a current CU or a current PU. A prediction block can be referred to as a prediction picture block or a picture prediction block. A reconstructed picture block can be referred to as a reconstructed block or a picture reconstructed block.

In some embodiments, the prediction unit 210 includes an inter prediction unit 211 and an intra prediction unit 212. Since there is a strong correlation between neighbouring samples in a video picture, intra prediction is used in the video coding technology to eliminate spatial redundancy between neighbouring samples. Since there is a strong similarity between neighbouring pictures in a video, inter prediction is used in the video coding technology to eliminate temporal redundancy between neighbouring pictures, thereby improving encoding efficiency.

The inter prediction unit 211 can be used for inter prediction. The inter prediction can include motion estimation and motion compensation. In inter prediction, reference can be made to picture information of different pictures. In inter prediction, a reference block is found from a reference picture according to motion information, and a prediction block is generated according to the reference block to eliminate temporal redundancy. A frame for which inter prediction is used can be a P frame and/or a B frame, where P frame refers to a forward prediction frame, and B frame refers to bidirectional prediction frame. The motion information includes a reference picture list containing the reference picture, a reference picture index, and a motion vector (MV). The MV can be an integer-sample MV or a fractional-sample MV. If the MV is a fractional-sample MV, interpolation filtering on the reference picture is required to generate a required fractional-sample block. Here, an integer-sample block or fractional-sample block found in the reference picture according to the MV is called a reference block. In some technologies, the reference block can be called a prediction block, and in some technologies, the prediction block will be generated based on the reference block. Generating the prediction block based on the reference block can also be understood as taking the reference block as a prediction block and then processing to generate a new prediction block based on the prediction block.

The intra prediction unit 212 is configured to predict sample information of the current picture block only with reference to information of the same picture, so as to eliminate spatial redundancy. A frame used for intra prediction can be an I frame. For example, as illustrated in FIG. 5, a white 4×4 block represents the current block, and gray samples on the left column and the above row of the current block are reference samples of the current block and are used for intra prediction of the current block. These reference samples may all be available, i.e. they have all been coded. Alternatively, some of the reference samples may not be available. For example, if the current block is on the leftmost of a picture, the reference samples on the left of the current block are not available. For another example, when coding the current block, the samples on the bottom left of the current block have not yet been coded, and in this case, reference samples on the bottom left are also not available. For the case where reference samples are not available, available reference samples, some values, or some methods can be used for filling, or no filling may be performed.

In some embodiments, the method for intra prediction further includes a multiple reference line (MRL) intra prediction method. In MRL, more reference samples can be used so as to improve encoding efficiency.

Further, there are multiple prediction modes for intra prediction. In H.264, there are nine modes for intra prediction of a 4×4 block. In mode 0, samples above the current block are copied vertically to the current block as prediction values. In mode 1, reference samples on the left of the current block are copied horizontally to the current block as prediction values. In mode 2 (direct current (DC)), an average value of eight samples (A˜D and I˜L) is taken as the prediction value of all samples. In mode 3 to mode 8, reference samples are copied to corresponding positions in the current block according to a certain angle, and since some positions in the current block may not correspond exactly to the reference sample, a weighted average of reference samples or interpolated factional samples of the reference samples may be required.

In high efficiency video coding (HEVC), a total of 35 prediction modes are used as intra prediction modes, including Planar, DC, and 33 angular modes. In versatile video coding (VVC), a total of 67 prediction modes are used as intra prediction modes, including Planar, DC, and 65 angular modes. In audio video coding standard (AVS) 3, a total of 66 prediction modes are used as intra prediction modes, including DC, Planar, bilinear, and 63 angular modes.

It should be noted that, with increase of the number (that is, quantity) of angular modes, intra prediction will be more accurate, which will better meet requirements for development of high-definition and ultra-high-definition digital video.

The residual unit 220 can generate a residual block of the CU based on a sample block of the CU and a prediction block of a PU of the CU. For example, the residual unit 220 can generate the residual block of the CU such that each sample in the residual block has a value equal to a difference between a sample in the sample block of the CU and a corresponding sample in the prediction block of the PU of the CU.

The transform/quantization unit 230 can quantize a transform coefficient. The transform/quantization unit 230 can quantize a transform coefficient associated with a TU of a CU based on a quantization parameter (QP) value associated with the CU. The video encoder 200 can adjust the degree of quantization applied to a transform coefficient associated with the CU by adjusting the QP value associated with the CU.

The inverse transform/quantization unit 240 can perform inverse quantization and inverse transform respectively on the quantized transform coefficient, to reconstruct a residual block according to the quantized transform coefficient.

The reconstruction unit 250 can add samples in the reconstructed residual block to corresponding samples in one or more prediction blocks generated by the prediction unit 210, to generate a reconstructed picture block associated with the TU. By reconstructing sample blocks of each TU of the CU in this way, the video encoder 200 can reconstruct the sample block of the CU.

The in-loop filtering unit 260 can perform deblocking filtering operations to reduce blocking artifacts of the sample block associated with the CU.

In some embodiments, the in-loop filtering unit 260 includes a deblocking filtering unit, a sample adaptive offset (SAO) unit, and an adaptive loop filtering (ALF) unit.

The decoded picture buffer 270 can store reconstructed sample blocks. The inter prediction unit 211 can use reference pictures including reconstructed sample blocks to perform inter prediction on PUs of other pictures. In addition, the intra prediction unit 212 can use the reconstructed sample blocks in the decoded picture buffer 270 to perform intra prediction on other PUs in the same picture as the CU.

The entropy coding unit 280 can receive the quantized transform coefficient from the transform/quantization unit 230. The entropy coding unit 280 can perform one or more entropy coding operations on the quantized transform coefficient to generate entropy coded data.

The basic procedure of video encoding in the disclosure is as follows. At an encoding end, the current picture is partitioned into blocks, and for the current block, the prediction unit 210 performs intra prediction or inter prediction to generate a prediction block of the current block. The residual unit 220 can calculate a residual block based on the prediction block and an original block of the current block, that is, a difference between the prediction block and the original block of the current block, where the residual block can also be referred to as residual information. The residual block can be transformed and quantized by the transform/quantization unit 230 to remove information that is not sensitive to human eyes, so as to eliminate visual redundancy. Optionally, the residual block before being transformed and quantized by the transform/quantization unit 230 can be called a time-domain residual block, and the time-domain residual block after being transformed and quantized by the transform/quantization unit 230 can be called a frequency residual block or a frequency-domain residual block. The entropy coding unit 280 receives the quantized transformation coefficient output by the transform/quantization unit 230, and can perform entropy coding on the quantized transformation coefficient to output a bitstream. For example, the entropy coding unit 280 can eliminate character redundancy according to a target context model and probability information of a binary bitstream.

In addition, the video encoder performs inverse quantization and inverse transform on the quantized transform coefficient output by the transform/quantization unit 230 to obtain a residual block of the current block, and then adds the residual block of the current block to the prediction block of the current block to obtain a reconstructed block of the current block. As the encoding progresses, reconstructed blocks corresponding to other picture blocks in the current picture can be obtained, and the reconstructed blocks are spliced to obtain a reconstructed picture of the current picture. Since there is an error during encoding, in order to reduce the error, the reconstructed picture is filtered, for example, the reconstructed picture is filtered by using an ALF, so as to reduce a difference between a sample value of a sample in the reconstructed picture and an original sample value of a sample in the current picture. The filtered reconstructed picture is stored in the decoded picture buffer 270, and can be used as a reference picture for inter prediction on a subsequent picture.

It should be noted that, block partition information as well as mode information or parameter information for prediction, transformation, quantization, entropy coding, and in-loop filtering, etc. determined at the encoding end is carried in the bitstream when necessary. At a decoding end, the bitstream parsed and existing information is analyzed to determine the block partition information as well as the mode information or the parameter information for prediction, transformation, quantization, entropy coding, in-loop filtering, etc. that is the same as such information at the encoding end, so as to ensure the decoded picture obtained at the encoding end is the same as the decoded picture obtained at the decoding end.

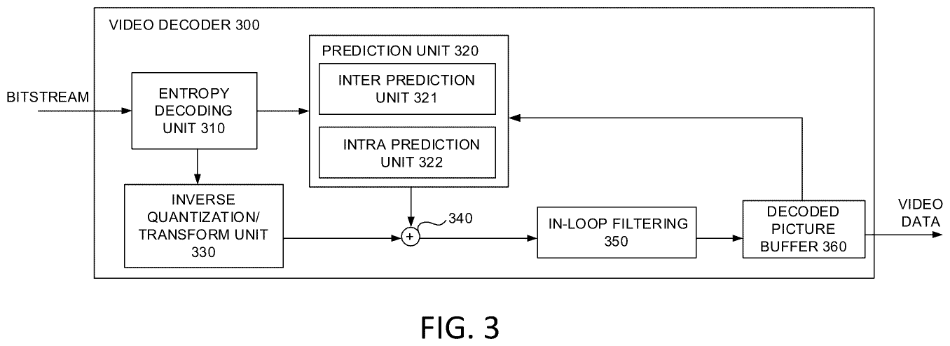

FIG. 3 is a schematic block diagram of a video decoder provided in embodiments of the disclosure.

As illustrated in FIG. 3, the video decoder 300 includes an entropy decoding unit 310, a prediction unit 320, an inverse quantization/transform unit 330, a reconstruction unit 340, an in-loop filtering unit 350, and a decoded picture buffer 360. It should be noted that, the video decoder 300 can include more, fewer, or different functional components.

The video decoder 300 can receive a bitstream. The entropy decoding unit 310 can parse the bitstream to extract syntax elements from the bitstream. As part of parsing the bitstream, the entropy decoding unit 310 can parse entropy-coded syntax elements in the bitstream. The prediction unit 320, the inverse quantization/transform unit 330, the reconstruction unit 340, and the in-loop filtering unit 350 can decode video data according to the syntax elements extracted from the bitstream, that is, generate decoded video data.

In some embodiments, the prediction unit 320 includes an inter prediction unit 321 and an intra prediction unit 322.

The intra prediction unit 322 can perform intra prediction to generate a prediction block of a PU. The intra prediction unit 322 can use an intra-prediction mode to generate a prediction block of the PU based on a sample block of spatially neighbouring PUs. The intra prediction unit 322 can also determine an intra prediction mode for the PU from one or more syntax elements parsed from the bitstream.

The inter prediction unit 321 can construct a first reference picture list (list 0) and a second reference picture list (list 1) according to the syntax elements parsed from the bitstream. In addition, the entropy decoding unit 310 can parse motion information of the PU if the PU is encoded by using inter prediction. The inter prediction unit 321 can determine one or more reference blocks of the PU according to the motion information of the PU. The inter prediction unit 321 can generate a prediction block of the PU based on one or more reference blocks of the PU.

The inverse quantization/transform unit 330 can perform inverse quantization on (that is, dequantize) a transform coefficient associated with a TU. The inverse quantization/transform unit 330 can use a QP value associated with a CU of the TU to determine the degree of quantization.

After inverse quantization of the transform coefficient, the inverse quantization/transform unit 330 can perform one or more inverse transformations on the inverse-quantized transform coefficient in order to generate a residual block associated with the TU.

The reconstruction unit 340 is configured to use the residual block associated with the TU of the CU and the prediction block of the PU of the CU to reconstruct a sample block of the CU. For example, the reconstruction unit 340 can add samples in the residual block to corresponding samples in the prediction block to reconstruct the sample block of the CU so as to obtain the reconstructed picture block.

The in-loop filtering unit 350 can perform deblocking filtering to reduce blocking artifacts of the sample block associated with the CU.

In some embodiments, the in-loop filtering unit 350 includes a deblocking filtering unit, an SAO unit, and an ALF unit.

The video decoder 300 can store the reconstructed picture of the CU in the decoded picture buffer 360. The video decoder 300 can use the reconstructed picture in the decoded picture buffer 360 as a reference picture for subsequent prediction, or transmit the reconstructed picture to a display apparatus in order for display.

The basic procedure of video decoding in the disclosure is as follows. The entropy decoding unit 310 can parse the bitstream to obtain prediction information, a quantization coefficient matrix, etc. of the current block, and the prediction unit 320 performs intra prediction or inter prediction on the current block based on the prediction information to generate a prediction block of the current block. The inverse quantization/transform unit 330 uses the quantization coefficient matrix obtained from the bitstream to perform inverse quantization and inverse transformation on the quantization coefficient matrix to obtain a residual block. The reconstruction unit 340 adds the prediction block and the residual block to obtain a reconstructed block. The reconstructed blocks form a reconstructed picture. The in-loop filtering unit 350 performs in-loop filtering on the reconstructed picture on a picture basis or on a block basis to obtain a decoded picture. The decoded picture can also be referred to as a reconstructed picture. The reconstructed picture can be displayed by a display apparatus, and on the other hand, can be stored in the decoded picture buffer 360 and used as a reference picture for inter prediction on a subsequent picture.

The above is the basic procedure of video codec under a block-based hybrid coding framework. With development of technology, some modules or steps of the framework or procedure can be optimized. The disclosure is applicable to the basic procedure of the video codec under the block-based hybrid coding framework, but is not limited to the framework and procedure.

Quantization technology involved in the disclosure will be introduced below.

Joint video expert team (JVET), an international video coding standard development organization, has established a group for research on a coding model beyond H.266/VVC, and the model, i.e., platform test software, is named enhanced compression model (ECM). In the ECM, newer and more efficient compression algorithms are introduced on the basis of version 10.0 of VVC reference software test platform (VVC test model (VTM)), and now has a higher encoding performance than VVC by about 13%. With the ECM, the size of a CU with a specific resolution is expanded, and lots of intra prediction technologies and inter prediction technologies are applied.

Technical solutions provided in embodiments of the disclosure can be understood as improvement on the ECM reference software in order to obtain higher encoding efficiency.

There are often changes in illumination intensity of video content in real natural videos, such as decrease of illumination intensity over time, obstruction of dark clouds, or change of flash intensity of a camera. The difference between previous and subsequent pictures in these video contents mainly lies in the intensity of the DC component of the picture, but there is substantially no change in texture information of the content. However, due to influence of large DC component value, these contents cannot be predicted effectively by means of motion search and motion compensation in inter prediction technology, and more residual information are likely to be encoded. With local illumination compensation (LIC) technology, it is possible to remove these DC redundant information, and predict luma changes accurately and implement corresponding compensation, which makes residual information smaller and improves encoding efficiency. In some embodiments, the LIC technology is referred to as illumination compensation for the sake of brevity.

The latest video coding standard H.266/VVC has been finalized. JVET proposes to explore a video coding standard which is beyond VVC in encoding performance on the basis of VVC, and conducts an exploratory experiment (EE2) for the purpose of beyond VVC. The platform reference software used in the exploratory experiment is based on VTM11.0. A new algorithm will be applied thereto and the branch will be changed to the ECM. In addition, multiple expert discussion groups are established for the ECM. The latest version 4.0 of the ECM reference software already has a higher encoding performance than VVC by about 15%, while VVC, which is currently the latest standard, is higher by only about 27% than the previous-generation video coding standard H.265/HEVC in encoding performance. It is likely to open a window for exploration and research on the next-generation video coding standard based on the ECM in the near future.

In the early stage of proposal of the ECM, coding tools which VVC does not support is already applied to the reference software, and these coding tools have high encoding performance and processing capability for different encoding scenarios in the ECM, including LIC.

The LIC in the ECM in some embodiments will be briefly introduced below.

An illumination compensation technology is an inter encoding technology. In an inter encoding process, for a current CU, a corresponding reference block is obtained according to MV information, where the reference block is usually from a different coding picture, in other words, a reference CU does not belong to a current picture. Different pictures have significant or slight change in some specific scenarios, and the illumination compensation technology is effective for processing some of the changes.

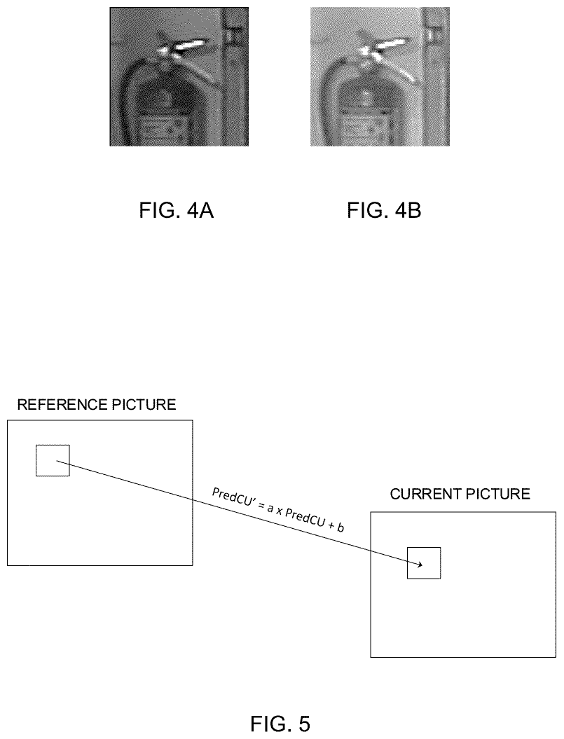

Taking FIG. 4A and FIG. 4B as examples, texture information in FIG. 4A and FIG. 4B is substantially the same, and the difference lies in luma change between the two. Since FIG. 4B appears very bright due to illumination by a camera flash while FIG. 4A is illuminated by normal natural light, there is difference between the two, and such difference results in heavy burden in video encoding. Supposing that FIG. 4B is used as a reference CU for FIG. 4A, the texture information of the two is the same, and therefore the difference in texture between the two is very slight, but an overall residual is very large. The reason is that samples in FIG. 4B as a whole has an offset due to illumination on the samples by the flash, and the residual between the two includes such offset. If the residual is directly transformed and quantized and then signalled into a bitstream, it will lead to high overhead.

In the illumination compensation technology in the ECM reference software, illumination change, such as influence caused by the flash or illumination change, is eliminated by means of linear fitting, so as to achieve better overall prediction effect.

In some embodiments, the illumination compensation technology is mainly as follows.

A correlation of change between prediction samples in the current CU (also referred to as current block) and reference samples is fitted with aid of a correlation between neighbouring reconstructed samples of a reference CU (also referred to as reference block) and neighbouring reconstructed samples of the current CU. The reason is that top reconstructed samples and left reconstructed samples neighbouring the current CU can be obtained if they exist, and top reconstructed samples and left reconstructed samples neighbouring a reference CU in a reference picture can also be obtained. A corresponding fitting model can be obtained by modeling reconstructed samples of the current picture and reconstructed samples of the reference picture.

In the modeling process, illumination compensation in the ECM is implemented through linear fitting, and the model is simplified as fitting illumination change between the current picture and the reference picture with a scaling parameter a and an offset parameter b. The relationship of change is expressed by formula (1):

$${Pred}^{′} ( x , y ) = a \cdot Pred ( x , yY ) + b \qquad ( 1 )$$

Pred(x,y) is a prediction block before illumination compensation, Pred′(x, y) is a prediction block after illumination compensation, a is a scaling parameter of an illumination compensation model, and b is an offset parameter of the illumination compensation model.

Both a and b in the formula are obtained by calculating picture information of the current picture and picture information of the reference picture, and are obtained by modelling reconstructed samples that are spatially neighbouring the current block and neighbouring samples of a reconstructed block in a corresponding reference picture. The derivation process is illustrated in formula (2):

$${Curr\_Rec}_{neigh} = a \cdot {Ref\_Rec}_{neigh} + b \qquad ( 2 )$$

Curr_Rec_{neigh} is a reconstructed picture of the current picture, and Ref_Rec_{neigh} is a reconstructed picture of the reference picture.

During coding of a digital video, a coding block in the current picture is refined with regard to illumination difference by using the illumination compensation model, to obtain a compensated prediction block, as illustrated in FIG. 5.

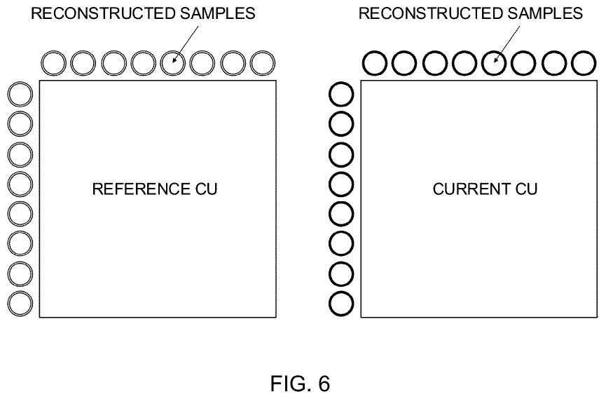

The scaling parameter a and the offset parameter b are calculated according to neighbouring reconstructed samples of a corresponding reference block in the reference picture and neighbouring reconstructed samples of the coding block in the current picture. The scaling parameter a and the offset parameter b are obtained by modelling according to the correlation between the neighbouring reconstructed samples of the CU in the current picture and neighbouring reconstructed samples of a reference block at a corresponding position in the reference picture, as illustrated in FIG. 6.

As illustrated in FIG. 6, reconstructed samples (also referred to as reconstructed pixels) are all nearest neighbouring reconstructed samples of a CU. A reference picture CU is a corresponding reconstructed CU in a reference picture, and is also referred to as a reference CU or a reference block. A current picture CU is a CU to-be-encoded in a current coding picture, and is also referred to as a current CU or a current block. A linear relationship is obtained by modelling corresponding reconstructed samples of the two pictures so as to obtain the scaling parameter a and the offset parameter b, and then the linear relationship is applied to the reference picture CU to obtain a prediction block of the current picture CU.

The illumination compensation model is a linear model in the ECM, and a model parameter includes the scaling factor a and the offset parameter b. Optionally, the scaling factor a and the offset parameter bare obtained by means of least square error. The quantity of reconstructed samples to-be-selected is set according to the width and the height of the current CU. If at least one of the width or the height of the current CU is equal to 4, 4 reconstructed samples are selected from top neighbouring reconstructed samples of the CU and 4 reconstructed samples are selected from left neighbouring reconstructed samples of the CU. For example, if the current CU has a width of 16 and a height of 4, all the 4 left neighbouring reconstructed samples are selected, and 4 top neighbouring reconstructed samples are selected at a step size of 3. If neither the width nor the height of the current CU is equal to 4, samples whose quantity is the logarithm of the minimum between the width and the height to 2 (log₂ (minimum between width and height)) are obtained from the top neighbouring reconstructed samples, and samples whose quantity is the logarithm of the minimum between the width and the height to 2 are obtained from the left neighbouring reconstructed samples.

The model parameters are calculated after obtaining the top reconstructed samples and the left reconstructed samples. Assuming that the reference reconstructed sample obtained is denoted by x and the reconstructed sample of the current block is denoted by y, then the sum of the reference reconstructed samples is denoted by sumX, the sum of the reconstructed samples of the current block is denoted by sumY, the sum of the reference reconstructed samples squared is denoted by sumXX, and the sum of the product of the reference reconstructed sample and the current reconstructed sample is denoted by sumXY, then the parameters a and b are calculated according to the following formula (3) and formula (4):

$$a = ( sumXY - sumXsumY ) / ( sumXX - sumXsumX ) \qquad ( 3 )$$

$$b = sumY - a * sumX \qquad ( 4 )$$

sumXsumY equals to sumX*sumY, and some shift operations involved in the calculation process in the ECM reference software are all simplified processes, which are not described in detail herein. After the linear model parameters are obtained, linear transformation is performed on a prediction block obtained after motion compensation, to obtain a final prediction block.

If the reconstructed sample for calculating the linear model parameters belongs to an inter prediction block, an interpolation operation is required.

In some embodiments, the illumination compensation technology in the ECM can be applied to common inter prediction, a merge prediction mode, and a sub-block mode. The common inter prediction is an inter mode. The merge prediction mode is a merge prediction technology, namely a Merge mode. The sub-block mode is an affine mode. In addition, the illumination compensation technology is applicable only in a single-frame prediction mode, but is not applicable to a multi-frame bi-directional reference mode.

In some embodiments, there is a relationship between the illumination compensation technology in the ECM and another technology adopted. For example, the illumination compensation technology is not applied together with a bi-directional optical flow (BDOF) technology or a symmetric motion vector difference (symmetric MVD, SMVD) technology.

In the illumination compensation technology described in the foregoing embodiments, when determining the parameters a and b, if both the top reconstructed sample and the left reference sample are available, the top reconstructed sample and the left reconstructed sample of the current block and the top reconstructed sample and the left reconstructed sample of the reference block are selected.

However, in some cases, for example, if samples in the coding block differ significantly, and most of them are similar to reconstructed samples at one side and are significantly different from reconstructed samples at the other side, the current coding block cannot be effectively predicted based on the top reconstructed samples and the left reconstructed samples, which has a problem of insufficient linear offset or over-offset.

In order to solve the above technical problem, in embodiments of the disclosure, the manner for reconstructed sample selection is extended, i.e. the reconstructed sample mode is extended, for example, a left reconstructed sample mode and/or a top reconstructed sample mode is introduced. Reconstructed samples in the left reconstructed sample mode are all from left neighbouring samples of a picture block, and reconstructed samples in the top reconstructed sample mode are all from top neighbouring samples of the picture block. In this way, when performing illumination compensation on a prediction value of the current block, it is possible to select from various reconstructed sample modes with regard to actual situations, thereby improving effect of illumination compensation and improving prediction performance.

The technical solutions provided in embodiments of the disclosure will be described in detail below with reference to embodiments.

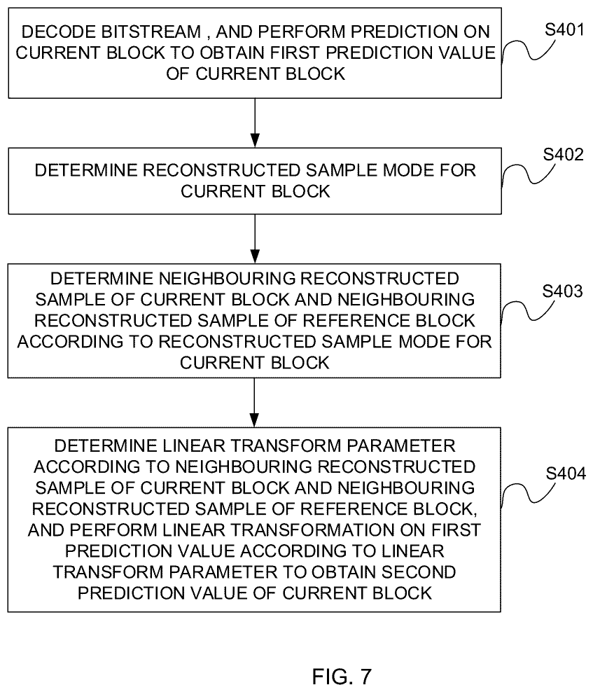

Firstly, a decoding end is taken as an example for illustration with reference to FIG. 7.

FIG. 7 is a schematic flowchart of a video decoding method provided in embodiments of the disclosure. The embodiments of the disclosure are applied to the video decoders illustrated in FIG. 1 and FIG. 3. As illustrated in FIG. 7, the method according to the embodiments of the disclosure includes the following.

S401, a bitstream is decoded, and prediction is performed on a current block to obtain a first prediction value of the current block.

When decoding the current block, at a decoding end, the bitstream is decoded to determine a prediction mode corresponding to the current block, and prediction is performed on the current block according to the prediction mode to obtain a prediction value of the current block. In embodiments of the disclosure, illumination compensation is performed on the prediction value obtained in this step to obtain a new prediction value. Therefore, for the convenience of illustration, in embodiments of the disclosure, a prediction value obtained according to a prediction mode is referred to as the first prediction value, and a prediction value obtained by performing illumination compensation on the first prediction value is referred to as a second prediction value.

There is no limitation on the prediction mode for the current block in embodiments of the disclosure.

In some embodiments, the current block is predicted by applying an inter prediction mode, so as to obtain the first prediction value of the current block. For example, the bitstream is decoded to obtain motion information corresponding to the current block, a reference block is found from a reference picture according to the motion information, and the first prediction value of the current block is obtained according to the reference block. Exemplarily, the motion information includes a reference picture list containing the reference picture, a reference picture index, and an MV. The MV can be an integer-sample MV or a fractional-sample MV. If the MV is a fractional-sample MV, interpolation filtering on the reference picture is required to generate a required fractional-sample block. Here, an integer-sample block or fractional-sample block found in the reference picture according to the MV is called a reference block. In some embodiments, the reference block is directly used as a prediction block. In some embodiments, a prediction block is generated by means of further processing based on the reference block.

S402, a reconstructed sample mode for the current block is determined.

The reconstructed sample mode is one of N candidate modes, and the N candidate modes include at least one of a top reconstructed sample mode, a left reconstructed sample mode, or a top-and-left reconstructed sample mode.

It should be noted that, there is no limitation on the order of implementation of S402 and S401. For example, S402 can be implemented before S401, or implemented after S401, or implemented concurrently with S401, and embodiments of the disclosure are not limited in this regard.

As can be seen, in order to improve prediction effect, illumination compensation is performed on the obtained first prediction value to obtain a second prediction value. Specifically, a neighbouring reconstructed sample(s) of the current block and a neighbouring reconstructed sample(s) of the reference block are determined, a linear transform parameter is determined according to the neighbouring reconstructed sample of the current block and the neighbouring reconstructed sample of the reference block, and linear transformation is performed on the first prediction value according to the linear transform parameter to obtain the second prediction value of the current block.

In order to improve illumination compensation effect, several new manners for reconstructed sample determination are introduced in embodiments of the disclosure, for example, the top reconstructed sample mode and/or the left reconstructed sample mode is introduced.

The left reconstructed sample mode means that samples in the neighbouring reconstructed samples of the current block are all from left neighbouring reconstructed samples of the current block, and samples in the neighbouring reconstructed samples of the reference block are all from left neighbouring reconstructed samples of the reference block.

The top reconstructed sample mode means that reconstructed samples in the neighbouring reconstructed samples of the current block are all from top neighbouring reconstructed samples of the current block, and reconstructed samples in the neighbouring reconstructed samples of the reference block are all from top neighbouring reconstructed samples of the reference block.

The top-and-left reconstructed sample mode means that the reconstructed samples in the neighbouring reconstructed samples of the current block are all from the top neighbouring reconstructed samples and the left neighbouring reconstructed samples of the current block, and the reconstructed samples in the neighbouring reconstructed samples of the reference block are all from the top neighbouring reconstructed samples and the left neighbouring reconstructed samples of the reference block.

In this way, at the decoding end, when performing decoding, the reconstructed sample mode for the current block is firstly determined. The reconstructed sample mode for the current block can be one of N candidate modes, and the N candidate modes include at least one of the top reconstructed sample mode, the left reconstructed sample mode, or the top-and-left reconstructed sample mode. That is, in embodiments of the disclosure, the reconstructed sample mode for the current block can be one of the top reconstructed sample mode, the left reconstructed sample mode, or the top-and-left reconstructed sample mode. In this way, the mode for reconstructed sample selection is diversified, and on the other hand, it is possible to determine accurately a reconstructed sample mode adapted to characteristic information of the current block from various modes described above. As such, based on an accurate reconstructed sample mode, the neighbouring reconstructed sample of the current block and the neighbouring reconstructed sample of the reference block can be determined more accurately, then the linear transform parameter is determined based on the neighbouring reconstructed sample of the current block and the neighbouring reconstructed sample of the reference block, and linear transformation is performed on the first prediction value of the current block according to the linear transform parameter to obtain an accurate second prediction value, which can improve effect of illumination compensation on the current block, thereby improving prediction effect on the current block.

In embodiments of the disclosure, the manner for determining the reconstructed sample mode for the current block at the decoding end includes, but is not limited to, the following manners.
Manner I: the reconstructed sample mode for the current block is indicated by an index. In this case, S402 includes step S402-A1 and step S402-A2 below.
S402-A1, a first index is determined, where the first index indicates the reconstructed sample mode.
S402-A2, the reconstructed sample mode for the current block is determined according to the first index corresponding to the current block.

In manner I, the reconstructed sample mode for the current block is indicated by the first index. In this way, at the decoding end, when determining the reconstructed sample mode for the current block, the first index is firstly determined, and then the reconstructed sample mode for the current block is determined according to the first index.

Exemplarily, assume that the N candidate modes are those illustrated in table 1:

TABLE 1

| Index | Candidate mode |
|---|---|
| 0 | Top reconstructed sample mode |
| 1 | Left reconstructed sample mode |
| 2 | Top-and-left reconstructed sample mode |
| . . . | . . . |

There is no limitation on the specific modes and the quantity of modes in the N candidate modes in embodiment of the disclosure. Exemplarily, as illustrated in table 1, the N candidate modes include the top reconstructed sample mode, the left reconstructed sample mode, and the top-and-left reconstructed sample mode, where an index of the top reconstructed sample mode is 0, an index of the left reconstructed sample mode is 1, and an index of the top-and-left reconstructed sample mode is 2. It should be noted that, the indexes corresponding to the modes illustrated in table 1 are only an example, and the disclosure is not limited thereto.

As illustrated in table 1, each candidate mode corresponds to one index, so that at the decoding end, when determining the reconstructed sample mode for the current block, the first index can be determined, and the reconstructed sample mode for the current block can be determined according to the first index. For example, if the first index is 1, and index 1 corresponds to the left reconstructed sample mode as illustrated in table 1, then at the decoding end, it is determined that the reconstructed sample mode for the current block is the left reconstructed sample mode.

The manner for determining the first index corresponding to the current block in S402-A1 includes, but is not limited to, the following manners.
Manner 1, the first index corresponding to the current block is obtained by decoding the bitstream.

Specifically, at an encoding end, one of the N candidate modes are selected, for example, a candidate mode with the minimum cost is selected as the reconstructed sample mode for the current block, and the first index of the reconstructed sample mode is signalled into the bitstream. In this way, at the decoding end, when performing decoding, the first index is obtained by decoding the bitstream, and then the reconstructed sample mode for the current block is determined according to the first index.

In manner 1, at the decoding end, the first index can be obtained directly from the bitstream. Such calculation process is simple, and it is possible to reduce decoding complexity at the decoding end, thereby improving decoding efficiency at the decoding end.
Manner 2, if the prediction mode for the current block is a Merge mode, at the decoding end, the first index is determined according to step S402-A1-11 and step S402-A1-12 below.
S402-A1-11, a first flag of a neighbouring block of the current block is determined, where the first flag of the neighbouring block indicates whether an illumination compensation technology is applied to the neighbouring block.
S402-A1-12, the first index is determined according to the first flag of the neighbouring block.

In manner 2, at the decoding end, if it is determined that the prediction mode for the current block is the Merge mode, the first index can be determined according to related decoding information of the neighbouring block of the current block. The neighbouring block of the current block is a decoded block. The related decoding information of the neighbouring block is given. When decoding the current block, at the decoding end, the decoding information of the neighbouring block can be obtained from the neighbouring block.

Optionally, the neighbouring block of the current block can be a top neighbouring block of the current block.

Optionally, the neighbouring block of the current block can be a left neighbouring block of the current block.

In some embodiments, the illumination compensation technology provided in embodiments of the disclosure is referred to as an illumination compensation technology.

At the decoding end, when performing illumination compensation on the current block, if the prediction mode for the current block is the Merge mode, whether the current block uses the illumination compensation technology is determined according to whether the neighbouring block of the current block uses the illumination compensation technology. For example, if the neighbouring block uses the illumination compensation technology, it is determined that the current block also uses the illumination compensation technology.

Based on this, at the decoding end, the first flag of the neighbouring block is obtained from the neighbouring block, where the first flag of the neighbouring block indicates whether the neighbouring block uses the illumination compensation technology, and then the first index is determined according to the first flag of the neighbouring block.

There is no limitation on the manner for determining the first index according to the first flag of the neighbouring block in S402-A1-12 in embodiments of the disclosure.

In a possible implementation, if the first flag of the neighbouring block indicates that the neighbouring block uses an LIC technology, the first index is determined to be a default index, where the default index indicates the top-and-left reconstructed sample mode. That is, in this implementation, if the prediction mode for the current block is the Merge mode and the neighbouring block of the current block uses the illumination compensation technology, the top-and-left reconstructed sample mode is used to perform illumination compensation on the first prediction value of the current block, so as to obtain the second prediction value of the current block.

In another possible implementation, if the first flag of the neighbouring block indicates that the neighbouring block uses the illumination compensation technology, a second index is determined, where the second index indicates a reconstructed sample mode for the neighbouring block; and the second index is determined as the first index. In this implementation, if the prediction mode for the current block is the Merge mode and the neighbouring block of the current block uses the illumination compensation technology, not only the flag of the neighbouring block but also the index of the neighbouring block is used as those of the current block, and then the second index corresponding to the neighbouring block is determined as the first index of the current block.

In some embodiments, if the first flag of the neighbouring block indicates that the neighbouring block does not use the LIC technology, it is determined that the current block also does not use an extended illumination compensation scheme provided in embodiments of the disclosure, and instead, illumination compensation is performed on the current block in the same illumination compensation manner as the neighbouring block. For example, illumination compensation is performed on the first prediction value of the current block by using the top-and-left reconstructed sample mode, so as to obtain the second prediction value of the current block. Alternatively, no illumination compensation is performed on the first prediction value of the current block.
Manner 3: if the prediction mode for the current block is a non-Merge mode, at the decoding end, the first index is determined according to step S402-A1-21 to step S402-A1-23 below.
S402-A1-21, a first flag of the current block is determined, where the first flag of the current block indicates whether the current block uses an illumination compensation technology.
S402-A1-22, if the first flag of the current block indicates that the current block uses the illumination compensation technology, a second flag of the current block is determined, where the second flag of the current block indicates whether the current block uses an extended illumination compensation technology.
S402-A1-23, the first index is determined according to the second flag of the current block.

Exemplarily, if the first flag of the current block is 1, it indicates that the current block uses the illumination compensation technology; and if the first flag of the current block is 0, it indicates that the current block does not use the illumination compensation technology.

If the first flag of the current block indicates that the current block does not use the illumination compensation technology, for example, the first flag of the current block is 0, at the decoding end, the first prediction value is determined as the second prediction value, or the first prediction value is processed in other manners to obtain the second prediction value.

If the first flag of the current block indicates that the current block uses the illumination compensation technology, for example, the first flag of the current block is 1, at the decoding end, the second flag of the current block is determined, where the second flag of the current block indicates whether the current block uses the extended illumination compensation technology of the disclosure.

Exemplarily, if the second flag of the current block is 1, it indicates that the current block uses the extended illumination compensation technology; and if the second flag of the current block is 0, it indicates that the current block does not use the extended illumination compensation technology.

In embodiments of the disclosure, at the decoding end, the first index can be determined according to the second flag of the current block.

For example, if the second flag of the current block indicates that the current block uses the extended illumination compensation technology, the first index is obtained by decoding the bitstream.

For another example, if the second flag of the current block indicates that the current block does not use the extended illumination compensation technology, the first index is determined to be a default index, where the default index indicates the top-and-left reconstructed sample mode.

In some embodiments, at the decoding end, the first flag of the current block is obtained by decoding the bitstream. That is, at the encoding end, the first flag of the current block is determined, and the first flag of the current block is signalled into the bitstream; and at the decoding end, the first flag of the current block can be directly obtained by decoding.

In some embodiments, at the decoding end, the second flag of the current block is obtained by decoding the bitstream. That is, at the encoding end, the second flag of the current block is determined, and the second flag of the current block is signalled into the bitstream; and at the decoding end, the second flag of the current block can be directly obtained by decoding.

In some embodiments, the first flag includes at least one of: a sequence-level flag, a picture-level flag, or a block-level flag.

In one example, the first flag includes a sequence-level flag, where the sequence-level flag indicates whether a current sequence uses the illumination compensation technology.

Optionally, the sequence-level flag can be represented by sps_lic_enable_flag.

Optionally, the sequence-level flag can be located in a sequence header.

In another example, the first flag includes a picture-level flag, where the picture-level flag indicates whether a current picture uses the illumination compensation technology.

Optionally, the picture-level flag can be represented by ph_lic_enable_flag.

Optionally, the picture-level flag can be located in a picture header.

In another example, the first flag includes a block-level flag, where the block-level flag indicates whether a picture block uses the illumination compensation technology.

Optionally, the block-level flag can be represented by lic_flag.

In some embodiments, the first flag can further include a slice-level flag, a unit-level flag, etc.

In some embodiments, the second flag includes a block-level flag.

Optionally, the second flag can be represented by the syntax lic_ext.

Exemplarily, the second flag is lic_ext. If lic_ext=1, it is determined that the current block does not use the extended illumination compensation technology provided in the disclosure; and if lic_ext=0, it is determined that the current block uses the extended illumination compensation technology provided in the disclosure.

In a possible implementation, a CU-level syntax is as illustrated in table 2:

TABLE 2

| | |
|---|---|
| if(sps_lic_enable_flag && ph_lic_enable_flag){ | |
| lic_flag; | ae(v) |
| if(lic_flag){ // current block uses lic | |
| lic_ext; | ae(v) |
| if(lic_ext !=0){ // not use both top and left | |
| lic_index; // 0: top; 1: left | ae(v) |
| } | |
| } | |
| } | |

At the decoding end, the syntax illustrated in table 2 is parsed to obtain the first flag of the current block, including sps_lic_enable_flag && ph_lic_enable_flag. If sps_lic_enable_flag=1, it is determined that the current sequence uses the illumination compensation technology. Then at the decoding end, ph_lic_enable_flag is parsed; and if ph_lic_enable_flag=1, it is determined that the current picture or the current frame uses the illumination compensation technology. Then, at the decoding end, lic_flag is parsed; and if lic_flag=1, it indicates that the current block uses the illumination compensation technology. Then, at the decoding end, the second flag lic_ext of the current block is parsed. If lic_ext=0, it indicates that the current block does not use the extended illumination compensation technology provided in the disclosure. In this case, the reconstructed sample mode for the current block is determined to be the top-and-left reconstructed sample mode. If lic_ext=1, it indicates that the current block uses the extended illumination compensation technology provided in the disclosure. In this case, at the decoding end, the bitstream continues to be decoded to obtain the first index lic_index. If lic_index=0, the reconstructed sample mode for the current block is determined to be the top reconstructed sample mode; and if lic_index=1, the reconstructed sample mode for the current block is determined to be the left reconstructed sample mode.

In embodiments of the disclosure, at the decoding end, after determining the first index, the reconstructed sample mode for the current block is determined according to the first index, and the neighbouring reconstructed sample of the current block and the neighbouring reconstructed sample of the reference block are determined based on the reconstructed sample mode, then the linear transform parameter is determined according to the neighbouring reconstructed sample of the current block and the neighbouring reconstructed sample of the reference block, and linear transformation is performed on the first prediction value of the current block according to the linear transform parameter, so as to obtain the second prediction value of the current block, which is conducive to accuracy of illumination compensation on the current block.

At the decoding end, besides determining the reconstructed sample mode for the current block in manner I, the reconstructed sample mode for the current block can also be determined in manner II below.
Manner II: if the prediction mode for the current block is a Merge mode, the reconstructed sample mode for the current block is determined according to decoding information of a neighbouring block of the current block. In this case, S402 includes step S402-B1 and step S402-B2 below.
S402-B1, a first flag of the neighbouring block of the current block is determined, where the first flag of the neighbouring block indicates whether the neighbouring block uses an illumination compensation technology.
S402-B2, the reconstructed sample mode for the current block is determined according to the first flag of the neighbouring block.

In manner II, at the decoding end, if it is determined that the prediction mode for the current block is the Merge mode, the reconstructed sample mode for the current block is determined directly according to the first flag of the neighbouring block of the current block without determining the first index. Such process is advantageous in simplicity and effect.

For the process of determining the first flag of the neighbouring block of the current block in S402-B1, reference is made to the illustration of S402-A11, which is not elaborated again herein.

The manner for determining the reconstructed sample mode for the current block according to the first flag of the neighbouring block in S402-B2 includes, but is not limited to, the following manners.
Manner 1: if the first flag of the neighbouring block indicates that the neighbouring block uses the illumination compensation technology, it is determined that the reconstructed sample mode for the current block is the top-and-left reconstructed sample mode.

In manner 1, if the prediction mode for the current block is the Merge mode and the neighbouring block of the current block uses the illumination compensation technology, at the decoding end, it is determined by default that the reconstructed sample mode for the current block is the top-and-left reconstructed sample mode, and then illumination compensation is performed on the first prediction value of the current block directly by using the top-and-left reconstructed sample mode, so as to obtain the second prediction value of the current block.
Manner 2: if the first flag of the neighbouring block indicates that the neighbouring block uses the illumination compensation technology, a reconstructed sample mode for the neighbouring block is determined; and the reconstructed sample mode for the neighbouring block is determined as the reconstructed sample mode for the current block.

In manner 2, if the prediction mode for the current block is the Merge mode and the neighbouring block of the current block uses the illumination compensation technology, at the decoding end, the reconstructed sample mode for the neighbouring block of the current block is determined as the reconstructed sample mode for the current block. Specifically, at the decoding end, the reconstructed sample mode for the neighbouring block is obtained from the neighbouring block, and illumination compensation is performed on the first prediction value of the current block by using the reconstructed sample mode for the neighbouring block, to obtain the second prediction value.

The manner for determining the reconstructed sample mode for the neighbouring block of the current block at the decoding end at least includes the following several examples.
Example 1, at the decoding end, the reconstructed sample mode for the neighbouring block is obtained directly from the neighbouring block.
Example 2, at the decoding end, a second index is obtained from the neighbouring block, where the second index indicates the reconstructed sample mode for the neighbouring block; and then the reconstructed sample mode for the neighbouring block is determined according to the second index. For example, as illustrated in table 1, if the second index is 0, it is determined that the reconstructed sample mode for the neighbouring block is the top reconstructed sample mode.

In manner II, if prediction is performed on the current block by using the Merge mode, at the decoding end, the reconstructed sample mode for the current block is determined directly according to the first flag of the neighbouring block of the current block and/or the first index.

At the decoding end, after determining the reconstructed sample mode for the current block in manner I or manner II described above, step S403 is performed.

S403, the neighbouring reconstructed sample of the current block and the neighbouring reconstructed sample of the reference block are determined according to the reconstructed sample mode for the current block.

The neighbouring reconstructed sample of the current block is a reconstructed sample determined from the left reconstructed samples and/or the top reconstructed samples of the current block according to the reconstructed sample mode for the current block.

The neighbouring reconstructed sample of the reference block of the current block is a reconstructed sample determined from the left reconstructed samples and/or the top reconstructed samples of the reference block of the current block according to the reconstructed sample mode for the current block.

In embodiments of the disclosure, when the reconstructed sample mode for the current block varies, the neighbouring reconstructed sample of the current block and the neighbouring reconstructed sample of the reference block determined vary accordingly.

The foregoing S403 will be elaborated below by taking the left reconstructed sample mode and the top reconstructed sample mode as examples.

In some embodiments, if the reconstructed sample mode for the current block is the left reconstructed sample mode, S403 includes the following step S403-A.

S403-A, the neighbouring reconstructed sample of the current block is determined according to the left neighbouring sample(s) of the current block, and a neighbouring reconstructed sample of a reference block corresponding to the current block in a reference picture is determined according to a left neighbouring sample(s) of the reference block.

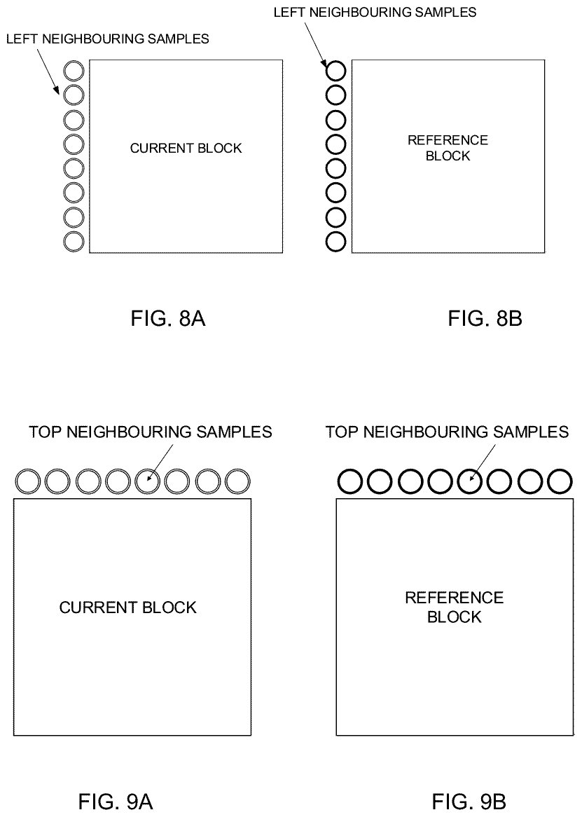

In the embodiments, if the reconstructed sample mode for the current block is the left reconstructed sample mode, the neighbouring reconstructed sample of the current block is determined from the left neighbouring samples, where the left neighbouring samples are all reconstructed samples. For example, as illustrated in FIG. 8A, the neighbouring reconstructed sample of the current block is determined from the left neighbouring samples of the current block. For another example, the reference block of the current block is determined from the reference picture. As illustrated in FIG. 8B, the neighbouring reconstructed sample of the reference block in the reference picture is determined from the left neighbouring samples of the reference block. Then the linear transform parameter is determined according to the neighbouring reconstructed sample of the current block and the neighbouring reconstructed sample of the reference block, and linear transformation is performed on the first prediction value of the current block according to the linear transform parameter, so as to obtain the second prediction value of the current block.

There is no limitation on the manner for determining the neighbouring reconstructed sample of the current block according to the left neighbouring sample of the current block in S403-A in embodiments of the disclosure.

In an implementation, multiple reconstructed samples neighbouring the left of the current block are determined as the neighbouring reconstructed samples of the current block.

In another implementation, as illustrated in FIG. 8A, the neighbouring reconstructed sample of the current block is determined according to the height of the current block and the left neighbouring sample of the current block.
Example 1, a reconstructed sample(s) which is neighbouring the left of the current block and is within the height range of the current block is determined as the neighbouring reconstructed sample of the current block. For example, if the height of the current block is 4, 4 reconstructed samples neighbouring the left of the current block are determined as the neighbouring reconstructed samples of the current block.
Example 2, if the height of the current block is equal to a first value, samples of which the quantity is the first value are selected from the left neighbouring samples of the current block and determined as the neighbouring reconstructed samples of the current block.

There is no limitation on the specific value of the first value in embodiments of the disclosure.

Optionally, the first value is 4. That is, if the height of the current block is equal to 4, 4 samples are selected from the left neighbouring samples of the current block and determined as the neighbouring reconstructed samples of the current block.

Example 2, if the height of the current block is not equal to the first value, samples of which the quantity is a second value are selected from the left neighbouring samples of the current block and determined as the neighbouring reconstructed samples of the current block.

There is no limitation on the specific value of the second value in embodiments of the disclosure.

Exemplarily, the second value is greater than or equal to 4.

Optionally, the second value is a value obtained by rounding the logarithm of the height to the third value as the base (log_{third value} (height)).

There is no limitation on the specific value of the third value in embodiments of the disclosure.

Optionally, the third value is 2.

The second value is a value obtained by rounding the value of log₂(height).

For example, assuming that the height of the current block is 32, it is determined that the second value is 5. Then at the decoding end, 5 samples are selected from 16 left neighbouring samples of the current block and used as the neighbouring reconstructed samples of the current block. The 5 samples can be selected at an equal step size, or can be selected randomly, which is not limited in embodiments of the disclosure.

Likewise, in embodiments of the disclosure, there is no limitation on manner for determining the neighbouring reconstructed sample of the reference block corresponding to the current block in the reference picture according to the left neighbouring sample of the reference block in S403-A.

In an implementation, multiple reconstructed samples neighbouring the left of the reference block in the reference picture are determined as the neighbouring reconstructed samples of the reference block.

In another implementation, as illustrated in FIG. 8B, the neighbouring reconstructed sample of the reference block is determined according to the height of the reference block and the left neighbouring sample of the reference block.
Example 1, a reconstructed sample(s) which is neighbouring the left of the reference block in the reference picture and is within the height range of the reference block is determined as the neighbouring reconstructed sample of the reference block. For example, if the height of the reference block is 4, 4 reconstructed samples neighbouring the left of the reference block in the reference picture are determined as the neighbouring reconstructed samples of the reference block.
Example 2, if the height of the reference block is equal to a first value, interpolation is performed on the left neighbouring samples of the reference block to obtain samples, of which the quantity is the first value, as the neighbouring reconstructed samples of the reference block.

There is no limitation on the specific value of the first value in embodiments of the disclosure.

Optionally, the first value is 4. That is, if the height of the reference block is equal to 4, interpolation is performed on the left neighbouring samples of the reference block to obtain 4 samples, and the 4 samples are used as the neighbouring reconstructed samples of the reference block.

Example 2, if the height of the reference block is not equal to the first value, interpolation is performed on the left neighbouring samples of the reference block to obtain samples, of which the quantity is a second value, as the neighbouring reconstructed samples of the reference block.

There is no limitation on the specific value of the second value in embodiments of the disclosure.

Exemplarily, the second value is greater than or equal to 4.

Optionally, the second value is a value obtained by rounding the logarithm of the height to the third value as the base.

There is no limitation on the specific value of the third value in embodiments of the disclosure.

Optionally, the third value is 2.

The second value is a value obtained by rounding the value of log₂(height).

For example, assuming that the height of the reference block is 32, the second value is determined to be 5. Then at the decoding end, interpolation is performed on 16 left neighbouring samples of the reference block to obtain 5 samples as the neighbouring reconstructed samples of the reference block.

In embodiments of the disclosure, if the reconstructed sample mode for the current block is the left reconstructed sample mode, the neighbouring reconstructed sample of the current block and the neighbouring reconstructed sample of the reference block are determined in any of the foregoing manners, where the neighbouring reconstructed sample of the current block depends only on the left neighbouring sample of the current block, and the neighbouring reconstructed sample of the reference block depends only on the left neighbouring sample of the reference block.

In some embodiments, if the reconstructed sample mode for the current block is the top reconstructed sample mode, the foregoing S403 includes the following step S403-B.

S403-B, the neighbouring reconstructed sample of the current block is determined according to the top neighbouring sample(s) of the current block, and a neighbouring reconstructed sample of a reference block corresponding to the current block in a reference picture is determined according to a top neighbouring sample(s) of the reference block.

In the embodiments, if the reconstructed sample mode for the current block is the top reconstructed sample mode, the neighbouring reconstructed sample of the current block is determined from the top neighbouring samples, where the top neighbouring samples are all reconstructed samples. For example, as illustrated in FIG. 9A, the neighbouring reconstructed sample of the current block is determined from the top neighbouring samples of the current block. For another example, the reference block of the current block is determined from the reference picture. As illustrated in FIG. 9B, the neighbouring reconstructed sample of the reference block in the reference picture is determined from the top neighbouring samples of the reference block. Then the linear transform parameter is determined according to the neighbouring reconstructed sample of the current block and the neighbouring reconstructed sample of the reference block, and linear transformation is performed on the first prediction value of the current block according to the linear transform parameter, so as to obtain the second prediction value of the current block.

There is no limitation on the manner for determining the neighbouring reconstructed sample of the current block according to the top neighbouring sample of the current block in S403-B in embodiments of the disclosure.

In an implementation, multiple reconstructed samples neighbouring the top of the current block are determined as the neighbouring reconstructed samples of the current block.

In another implementation, as illustrated in FIG. 9A, the neighbouring reconstructed sample of the current block is determined according to the width of the current block and the top neighbouring sample of the current block.
Example 1, a reconstructed sample(s) which is neighbouring the top of the current block and is within the width range of the current block is determined as the neighbouring reconstructed sample of the current block. For example, if the width of the current block is 4, 4 reconstructed samples neighbouring the top of the current block are determined as the neighbouring reconstructed samples of the current block.
Example 2, if the width of the current block is equal to a first value, samples of which the quantity is the first value are selected from the top neighbouring samples of the current block and determined as the neighbouring reconstructed samples of the current block.

There is no limitation on the specific value of the first value in embodiments of the disclosure.

Optionally, the first value is 4. That is, if the width of the current block is equal to 4, 4 samples are selected from the top neighbouring samples of the current block and determined as the neighbouring reconstructed samples of the current block.

Example 2, if the width of the current block is not equal to the first value, samples of which the quantity is a second value are selected from the top neighbouring samples of the current block and determined as the neighbouring reconstructed samples of the current block.

There is no limitation on the specific value of the second value in embodiments of the disclosure.

Exemplarily, the second value is greater than or equal to 4.

Optionally, the second value is a value obtained by rounding the logarithm of the width to the third value as the base.

There is no limitation on the specific value of the third value in embodiments of the disclosure.

Optionally, the third value is 2.

The second value is a value obtained by rounding the value of log₂(width).

For example, assuming that the width of the current block is 32, it is determined that the second value is 5. Then at the decoding end, 5 samples are selected from 16 top neighbouring samples of the current block and used as the neighbouring reconstructed samples of the current block. The 5 samples can be selected at an equal step size, or can be selected randomly, which is not limited in embodiments of the disclosure.

Likewise, in embodiments of the disclosure, there is no limitation on manner for determining the neighbouring reconstructed sample of the reference block corresponding to the current block in the reference picture according to the top neighbouring sample of the reference block in S403-B.

In an implementation, multiple reconstructed samples neighbouring the top of the reference block in the reference picture are determined as the neighbouring reconstructed samples of the reference block.

In another implementation, as illustrated in FIG. 9B, the neighbouring reconstructed sample of the reference block is determined according to the width of the reference block and the top neighbouring sample of the reference block.
Example 1, a reconstructed sample(s) which is neighbouring the top of the reference block in the reference picture and is within the width range of the reference block is determined as the neighbouring reconstructed sample of the reference block. For example, if the width of the reference block is 4, 4 reconstructed samples neighbouring the top of the reference block in the reference picture are determined as the neighbouring reconstructed samples of the reference block.
Example 2, if the width of the reference block is equal to a first value, interpolation is performed on the top neighbouring samples of the reference block to obtain samples, of which the quantity is the first value, as the neighbouring reconstructed samples of the reference block.

There is no limitation on the specific value of the first value in embodiments of the disclosure.

Optionally, the first value is 4. That is, if the width of the reference block is equal to 4, interpolation is performed on the top neighbouring samples of the reference block to obtain 4 samples, and the 4 samples are used as the neighbouring reconstructed samples of the reference block.
Example 2, if the width of the reference block is not equal to the first value, interpolation is performed on the top neighbouring samples of the reference block to obtain samples, of which the quantity is a second value, as the neighbouring reconstructed samples of the reference block.

There is no limitation on the specific value of the second value in embodiments of the disclosure.

Exemplarily, the second value is greater than or equal to 4.

Optionally, the second value is a value obtained by rounding the logarithm of the width to the third value as the base.

There is no limitation on the specific value of the third value in embodiments of the disclosure.

Optionally, the third value is 2.

The second value is a value obtained by rounding the value of log₂(width).

For example, assuming that the width of the reference block is 32, the second value is determined to be 5. Then at the decoding end, interpolation is performed on 16 top neighbouring samples of the reference block to obtain 5 samples as the neighbouring reconstructed samples of the reference block.

In embodiments of the disclosure, if the reconstructed sample mode for the current block is the top reconstructed sample mode, the neighbouring reconstructed sample of the current block and the neighbouring reconstructed sample of the reference block are determined in any of the foregoing manners, where the neighbouring reconstructed sample of the current block depends only on the top neighbouring sample of the current block, and the neighbouring reconstructed sample of the reference block depends only on the top neighbouring sample of the reference block.

At the decoding end, after determining the neighbouring reconstructed sample of the current block and the neighbouring reconstructed sample of the reference block according to the foregoing method, the following S404 is performed.

S404, the linear transform parameter is determined according to the neighbouring reconstructed sample of the current block and the neighbouring reconstructed sample of the reference block, and linear transformation is performed on the first prediction value according to the linear transform parameter to obtain the second prediction value of the current block.

In embodiments of the disclosure, there is no limitation on the manner for determining the linear transform parameter according to the neighbouring reconstructed sample of the current block and the neighbouring reconstructed sample of the reference block.

In some embodiments, if the linear transform parameter includes a scaling factor and an offset parameter, the linear transform parameter is determined according to the neighbouring reconstructed sample of the current block and the neighbouring reconstructed sample of the reference block in S404 as follows.
S404-A1, the scaling factor is determined according to the neighbouring reconstructed sample of the current block and the neighbouring reconstructed sample of the reference block.
S404-A2, the offset parameter is determined according to the neighbouring reconstructed sample of the current block, the neighbouring reconstructed sample of the reference block, and the scaling factor.

In embodiments of the disclosure, there is no limitation on the manner for determining the scaling factor a according to the neighbouring reconstructed sample of the current block and the neighbouring reconstructed sample of the reference block in S404-A1.

In a possible implementation, the scaling factor a is determined to be a ratio of the neighbouring reconstructed sample of the current block to the neighbouring reconstructed sample of the reference block.

In another possible implementation, the scaling factor a is determined according to the foregoing formula (3).

In embodiments of the disclosure, there is no limitation on the manner for determining the offset parameter according to the neighbouring reconstructed sample of the current block, the neighbouring reconstructed sample of the reference block, and the scaling factor in S404-A2.

In a possible implementation, the offset parameter b is determined according to the above formula (4).

After the linear transform parameter is determined according to the foregoing method, linear transformation is performed on the first prediction value by using the linear transform parameter, so as to obtain the second prediction value of the current block. For example, a product of the scaling factor and the first prediction value is determined; and a sum of the product and the offset parameter is determined as the second prediction value.

In an example, the second prediction value is determined according to formula (5) below.

$${P}^{′} ( x , y ) = a \cdot P ( x , y ) + b \qquad ( 5 )$$

P(x, y) represents a prediction block before illumination compensation, i.e. the first prediction value of the current block, and P′(x, y) represents a prediction block after illumination compensation, i.e. the second prediction value of the current block. a is the scaling parameter, and b is the offset parameter.

In some embodiments, if a current picture that the current block belongs to is a first-type picture, the extended illumination compensation technology provided in embodiments of the disclosure is implemented, that is, the foregoing S402 is performed to determine the reconstructed sample mode for the current block.

The type of the first-type picture is not limited in embodiments of the disclosure.

Optionally, if the first-type picture is a B frame, that is, the current picture is a B frame, the extended illumination compensation technology provided in the disclosure is enabled by default.

In some embodiments, if the area of the current block is greater than or equal to a preset threshold, the extended illumination compensation technology provided in embodiments of the disclosure is implemented, that is, the foregoing S402 is performed to determine the reconstructed sample mode for the current block.

There is no limitation on the value of the preset threshold in the disclosure.

Optionally, the preset threshold is 64, that is, the area of the current block is greater than or equal to the preset threshold, and then the extended illumination compensation technology provided in embodiments of the disclosure is implemented, that is, the foregoing S402 is performed to determine the reconstructed sample mode for the current block.

According to the video decoding method provided in embodiments of the disclosure, the bitstream is decoded, and prediction is performed on the current block to obtain the first prediction value of the current block. The reconstructed sample mode for the current block is determined, where the reconstructed sample mode is one of the N candidate modes, and the N candidate modes include at least one of the top reconstructed sample mode, the left reconstructed sample mode, or the top-and-left reconstructed sample mode. The neighbouring reconstructed sample of the current block and the neighbouring reconstructed sample of the reference block are determined according to the reconstructed sample mode for the current block. The linear transform parameter is determined according to the neighbouring reconstructed sample of the current block and the neighbouring reconstructed sample of the reference block, and linear transformation is performed on the first prediction value according to the linear transform parameter to obtain the second prediction value of the current block. In embodiments of the disclosure, the reconstructed sample mode for the current block can be one of the top reconstructed sample mode, the left reconstructed sample mode, or the top-and-left reconstructed sample mode. In this way, the mode for reconstructed sample selection is diversified, and on the other hand, it is possible to determine accurately a reconstructed sample mode adapted to characteristic information of the current block from various modes described above. As such, based on an accurate reconstructed sample mode, the neighbouring reconstructed sample of the current block and the neighbouring reconstructed sample of the reference block can be determined more accurately, then the linear transform parameter is determined based on the neighbouring reconstructed sample of the current block and the neighbouring reconstructed sample of the reference block that are obtained accurately, and linear transformation is performed on the first prediction value of the current block according to the linear transform parameter to obtain an accurate second prediction value, which can improve effect of illumination compensation on the current block, thereby improving prediction effect on the current block.

The video decoding method in embodiments of the disclosure are described above. Based on this, with respect to an encoding end, a video encoding method in the disclosure will be described below.

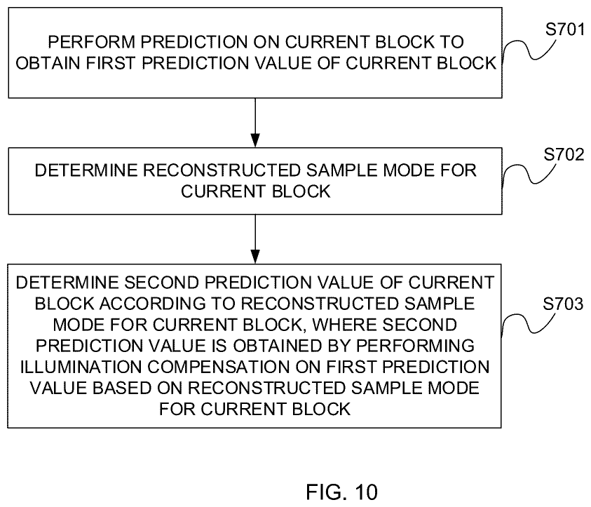

FIG. 10 is a schematic flowchart of a video encoding method provided in embodiments of the disclosure. An execution entity of embodiments of the disclosure can be the encoders illustrated in FIG. 1 and FIG. 2.

As illustrated in FIG. 10, the method according to embodiments of the disclosure includes the following.

S701, prediction is performed on a current block to obtain a first prediction value of the current block.

When encoding the current block, at an encoding end, a prediction mode corresponding to the current block is determined, and prediction is performed on the current block according to the prediction mode to obtain a prediction value of the current block. In embodiments of the disclosure, illumination compensation is performed on the prediction value obtained in this step to obtain a new prediction value. Therefore, for the convenience of illustration, in embodiments of the disclosure, a prediction value obtained according to a prediction mode is referred to as the first prediction value, and a prediction value obtained by performing illumination compensation on the first prediction value is referred to as a second prediction value.

There is no limitation on the prediction mode for the current block in embodiments of the disclosure.

In some embodiments, the current block is predicted by applying an inter prediction mode, so as to obtain the first prediction value of the current block. For example, at the encoding end, motion information corresponding to the current block is determined, a reference block is found from a reference picture according to the motion information, and the first prediction value of the current block is obtained according to the reference block. Exemplarily, the motion information includes a reference picture list containing the reference picture, a reference picture index, and an MV. The MV can be an integer-sample MV or a fractional-sample MV. If the MV is a fractional-sample MV, interpolation filtering on the reference picture is required to generate a required fractional-sample block. Here, an integer-sample block or fractional-sample block found in the reference picture according to the MV is called a reference block. In some embodiments, the reference block is directly used as a prediction block. In some embodiments, a prediction block is generated by means of further processing based on the reference block.

S702, a reconstructed sample mode for the current block is determined.

The reconstructed sample mode is one of N candidate modes, and the N candidate modes include at least one of a top reconstructed sample mode, a left reconstructed sample mode, or a top-and-left reconstructed sample mode.

It should be noted that, there is no limitation on the order of implementation of S702 and S701. For example, S702 can be implemented before S701, or implemented after S701, or implemented concurrently with S701, and embodiments of the disclosure are not limited in this regard.

As can be seen, in order to improve prediction effect, illumination compensation is performed on the obtained first prediction value to obtain a second prediction value. Specifically, a neighbouring reconstructed sample(s) of the current block and a neighbouring reconstructed sample(s) of the reference block are determined, a linear transform parameter is determined according to the neighbouring reconstructed sample of the current block and the neighbouring reconstructed sample of the reference block, and linear transformation is performed on the first prediction value according to the linear transform parameter to obtain the second prediction value of the current block.

In order to improve illumination compensation effect, several new manners for reconstructed sample determination are introduced in embodiments of the disclosure, for example, the top reconstructed sample mode and/or the left reconstructed sample mode is introduced.

The left reconstructed sample mode means that reconstructed samples in the neighbouring reconstructed samples of the current block are all from left neighbouring reconstructed samples of the current block, and reconstructed samples in the neighbouring reconstructed samples of the reference block are all from left neighbouring reconstructed samples of the reference block.

The top reconstructed sample mode means that reconstructed samples in the neighbouring reconstructed samples of the current block are all from top neighbouring reconstructed samples of the current block, and reconstructed samples in the neighbouring reconstructed samples of the reference block are all from top neighbouring reconstructed samples of the reference block.

The top-and-left reconstructed sample mode means that the reconstructed samples in the neighbouring reconstructed samples of the current block are all from the top neighbouring reconstructed samples and the left neighbouring reconstructed samples of the current block, and the reconstructed samples in the neighbouring reconstructed samples of the reference block are all from the top neighbouring reconstructed samples and the left neighbouring reconstructed samples of the reference block.

In this way, when performing encoding, at the encoding end, the reconstructed sample mode for the current block is firstly determined. The reconstructed sample mode for the current block can be one of the N candidate modes, and the N candidate modes include at least one of the top reconstructed sample mode, the left reconstructed sample mode, or the top-and-left reconstructed sample mode. That is, in embodiments of the disclosure, the manner for reconstructed sample selection is extended, i.e. the reconstructed sample mode is extended. For example, the left reconstructed sample mode and/or the top reconstructed sample mode is introduced, where reconstructed samples in the left reconstructed sample mode are all from left neighbouring samples of a picture block, and reconstructed samples in the top reconstructed sample mode are all from top neighbouring samples of the picture block. In this way, when performing illumination compensation on the prediction value of the current block, selection is performed from a variety of reconstructed sample modes according to actual situations, thereby improving effect of illumination compensation and improving prediction performance.

In embodiments of the disclosure, there is no limitation on the manner for determining the reconstructed sample mode for the current block.

In some embodiments, any one of the N candidate modes is determined as the reconstructed sample mode for the current block.

In some embodiments, the current block is analyzed, and the reconstructed sample mode for the current block is determined according to characteristics of samples in the current block. For example, if the samples in the current block differ significantly and most of them are similar to reconstructed samples on the top (that is, top reconstructed samples), the top reconstructed sample mode is determined as the reconstructed sample mode for the current block. If the samples in the current block differ significantly and most of them are similar to reconstructed samples on the left (that is, left reconstructed samples), the left reconstructed sample mode is determined as the reconstructed sample mode for the current block. If the samples in the current block do not differ significantly, the top-and-left reconstructed sample mode is determined as the reconstructed sample mode for the current block.

In some embodiments, S702 includes S702-A and S702-B below.
S702-A, for an i^{th} candidate mode in the N candidate modes, a cost corresponding to the i^{th} candidate mode is determined, where i is a positive integer and 1≤i≤N.
S702-B, the reconstructed sample mode for the current block is determined from the N candidate modes according to costs corresponding to the N candidate modes.

In the embodiments, at the encoding end, illumination compensation is performed on the first prediction value of the current block by applying each of the N candidate modes, so as to obtain a cost corresponding to each candidate mode, and then one of the N candidate modes is selected as the reconstructed sample mode for the current block according to the cost corresponding to each candidate mode.

In embodiments of the disclosure, the process of determining the cost corresponding to each of the N candidate modes is the same. For the convenience of illustration, the i^{th} candidate mode in the N candidate modes is taken as an example for illustration.

Determining the cost corresponding to the i^{th} candidate mode in S702-A includes the following steps S702-A1 to S702-A4.

S702-A1, an i^{th} neighbouring reconstructed sample of the current block and an i^{th} neighbouring reconstructed sample of a reference block are determined according to the i^{th} candidate mode.

The i^{th} neighbouring reconstructed sample of the current block is a reconstructed sample determined from the left reconstructed samples and/or the top reconstructed samples of the current block according to the i^{th} candidate mode.

The i^{th} neighbouring reconstructed sample of the reference block of the current block is a reconstructed sample determined from the left reconstructed samples and/or the top reconstructed samples of the reference block of the current block according to the i^{th} candidate mode.

In embodiments of the disclosure, if the i^{th} candidate mode varies, the Ah neighbouring reconstructed sample of the current block and the i^{th} neighbouring reconstructed sample of the reference block determined vary accordingly.

The foregoing S702-A1 will be elaborated below by taking the left reconstructed sample mode and the top reconstructed sample mode as examples.

In some embodiments, if the i^{th} candidate mode is the left reconstructed sample mode, S702-A1 includes the following step S702-A1-A.

S702-A1-A, the i^{th} neighbouring reconstructed sample of the current block is determined according to a left neighbouring sample(s) of the current block, and an th neighbouring reconstructed sample of a reference block corresponding to the current block in a reference picture is determined according to a left neighbouring sample(s) of the reference block.

In the embodiments, if the i^{th} candidate mode is the left reconstructed sample mode, the i^{th} neighbouring reconstructed sample of the current block is determined from the left neighbouring samples, where the left neighbouring samples are all reconstructed samples. For example, as illustrated in FIG. 8A, the i^{th} neighbouring reconstructed sample of the current block is determined from the left neighbouring samples of the current block. For another example, the reference block of the current block is determined from the reference picture. As illustrated in FIG. 8B, the i^{th} neighbouring reconstructed sample of the reference block in the reference picture is determined from the left neighbouring samples of the reference block. Then the linear transform parameter is determined according to the i^{th} neighbouring reconstructed sample of the current block and the i^{th} neighbouring reconstructed sample of the reference block, and linear transformation is performed on the first prediction value of the current block according to the linear transform parameter, so as to obtain the second prediction value of the current block.

There is no limitation on the manner for determining the i^{th} neighbouring reconstructed sample of the current block according to the left neighbouring sample of the current block in S702-A1-A in embodiments of the disclosure.

In an implementation, multiple reconstructed samples neighbouring the left of the current block are determined as the i^{th} neighbouring reconstructed sample of the current block.

In another implementation, as illustrated in FIG. 8A, the i^{th} neighbouring reconstructed sample of the current block is determined according to the height of the current block and the left neighbouring sample of the current block.
Example 1, a reconstructed sample(s) which is neighbouring the left of the current block and is within the height range of the current block is determined as the i^{th} neighbouring reconstructed sample of the current block. For example, if the height of the current block is 4, 4 reconstructed samples neighbouring the left of the current block are determined as the i^{th} neighbouring reconstructed sample of the current block.
Example 2, if the height of the current block is equal to a first value, samples of which the quantity is the first value are selected from the left neighbouring samples of the current block and determined as the i^{th} neighbouring reconstructed sample of the current block.

There is no limitation on the specific value of the first value in embodiments of the disclosure.

Optionally, the first value is 4. That is, if the height of the current block is equal to 4, 4 samples are selected from the left neighbouring samples of the current block and determined as the i^{th} neighbouring reconstructed sample of the current block.

Example 2, if the height of the current block is not equal to the first value, samples of which the quantity is a second value are selected from the left neighbouring samples of the current block and determined as the i^{th} neighbouring reconstructed sample of the current block.

There is no limitation on the specific value of the second value in embodiments of the disclosure.

Exemplarily, the second value is greater than or equal to 4.

Optionally, the second value is a value obtained by rounding the logarithm of the height to the third value as the base (log_{third value} (height)).

There is no limitation on the specific value of the third value in embodiments of the disclosure.

Optionally, the third value is 2, and then the second value is a value obtained by rounding the value of log₂(height).

For example, assuming that the height of the current block is 32, it is determined that the second value is 5. Then at the encoding end, 5 samples are selected from 16 left neighbouring samples of the current block and used as the h neighbouring reconstructed sample of the current block. The 5 samples can be selected at an equal step size, or can be selected randomly, which is not limited in embodiments of the disclosure.

Likewise, in embodiments of the disclosure, there is no limitation on manner for determining the i^{th} neighbouring reconstructed sample of the reference block corresponding to the current block in the reference picture according to the left neighbouring sample of the reference block in S702-A1-A.

In an implementation, multiple reconstructed samples neighbouring the left of the reference block in the reference picture are determined as the i^{th} neighbouring reconstructed sample of the reference block.

In another implementation, as illustrated in FIG. 8B, the i^{th} neighbouring reconstructed sample of the reference block is determined according to the height of the reference block and the left neighbouring sample of the reference block.
Example 1, a reconstructed sample(s) which is neighbouring the left of the reference block in the reference picture and is within the height range of the reference block is determined as the i^{th} neighbouring reconstructed sample of the reference block. For example, if the height of the reference block is 4, 4 reconstructed samples neighbouring the left of the reference block in the reference picture are determined as the i^{th} neighbouring reconstructed sample of the reference block.
Example 2, if the height of the reference block is equal to a first value, interpolation is performed on the left neighbouring samples of the reference block to obtain samples, of which the quantity is the first value, as the i^{th} neighbouring reconstructed sample of the reference block.

There is no limitation on the specific value of the first value in embodiments of the disclosure.

Optionally, the first value is 4. That is, if the height of the reference block is equal to 4, interpolation is performed on the left neighbouring samples of the reference block to obtain 4 samples, and the 4 samples are used as the i^{th} neighbouring reconstructed sample of the reference block.

Example 2, if the height of the reference block is not equal to the first value, interpolation is performed on the left neighbouring samples of the reference block to obtain samples, of which the quantity is a second value, as the i^{th} neighbouring reconstructed sample of the reference block.

For example, assuming that the height of the reference block is 32, the second value is determined to be 5. Then at the encoding end. interpolation is performed on 16 left neighbouring samples of the reference block to obtain 5 samples as the i^{th} neighbouring reconstructed sample of the reference block.

In embodiments of the disclosure, if the i^{th} candidate mode is the left reconstructed sample mode, the i^{th} neighbouring reconstructed sample of the current block and the i^{th} neighbouring reconstructed sample of the reference block are determined in any of the foregoing manners, where the i^{th} neighbouring reconstructed sample of the current block depends only on the left neighbouring sample of the current block, and the i^{th} neighbouring reconstructed sample of the reference block depends only on the left neighbouring sample of the reference block.

In some embodiments, if the i^{th} candidate mode is the top reconstructed sample mode, S702-A1 includes the following step S702-A1-B.

S702-A1-B, the i^{th} neighbouring reconstructed sample of the current block is determined according to the top neighbouring sample(s) of the current block, and an th neighbouring reconstructed sample of a reference block corresponding to the current block in a reference picture is determined according to a top neighbouring sample(s) of the reference block.

In the embodiments, if the i^{th} candidate mode is the top reconstructed sample mode, the i^{th} neighbouring reconstructed sample of the current block is determined from the top neighbouring samples, where the top neighbouring samples are all reconstructed samples. For example, as illustrated in FIG. 9A, the i^{th} neighbouring reconstructed sample of the current block is determined from the top neighbouring samples of the current block. For another example, the reference block of the current block is determined from the reference picture. As illustrated in FIG. 9B, the i^{th} reconstructed sample of the reference block in the reference picture is determined from the top neighbouring samples of the reference block. Then the linear transform parameter is determined according to the i^{th} neighbouring reconstructed sample of the current block and the i^{th} neighbouring reconstructed sample of the reference block, and linear transformation is performed on the first prediction value of the current block according to the linear transform parameter, so as to obtain the second prediction value of the current block.

There is no limitation on the manner for determining the i^{th} neighbouring reconstructed sample of the current block according to the top neighbouring sample of the current block in S702-A1-B in embodiments of the disclosure.

In an implementation, multiple reconstructed samples neighbouring the top of the current block are determined as the i^{th} neighbouring reconstructed sample of the current block.

In another implementation, as illustrated in FIG. 9A, the i^{th} neighbouring reconstructed sample of the current block is determined according to the width of the current block and the top neighbouring sample of the current block.
Example 1, a reconstructed sample(s) which is neighbouring the top of the current block and is within the width range of the current block is determined as the i^{th} neighbouring reconstructed sample of the current block. For example, if the width of the current block is 4, 4 reconstructed samples neighbouring the top of the current block are determined as the i^{th} neighbouring reconstructed sample of the current block.
Example 2, if the width of the current block is equal to a first value, samples of which the quantity is the first value are selected from the top neighbouring samples of the current block and determined as the i^{th} neighbouring reconstructed sample of the current block.

There is no limitation on the specific value of the first value in embodiments of the disclosure.

Optionally, the first value is 4. That is, if the width of the current block is equal to 4, 4 samples are selected from the top neighbouring samples of the current block and determined as the i^{th} neighbouring reconstructed sample of the current block.

Example 2, if the width of the current block is not equal to the first value, samples of which the quantity is a second value are selected from the top neighbouring samples of the current block and determined as the i^{th} neighbouring reconstructed sample of the current block.

There is no limitation on the specific value of the second value in embodiments of the disclosure.

Exemplarily, the second value is greater than or equal to 4.

Optionally, the second value is a value obtained by rounding the logarithm of the width to the third value as the base.

There is no limitation on the specific value of the third value in embodiments of the disclosure.

Optionally, the third value is 2.

For example, the second value is a value obtained by rounding the value of log₂(width).

For example, assuming that the width of the current block is 32, it is determined that the second value is 5. Then at the encoding end, 5 samples are selected from 16 top neighbouring samples of the current block and used as the i^{th} neighbouring reconstructed sample of the current block. The 5 samples can be selected at an equal step size, or can be selected randomly, which is not limited in embodiments of the disclosure.

Likewise, in embodiment of the disclosure, there is no limitation on manner for determining the i^{th} neighbouring reconstructed sample of the reference block corresponding to the current block in the reference picture according to the top neighbouring sample of the reference block in S702-A1-B.

In an implementation, multiple reconstructed samples neighbouring the top of the reference block in the reference picture are determined as the i^{th} neighbouring reconstructed sample of the reference block.

In another implementation, as illustrated in FIG. 9B, the i^{th} neighbouring reconstructed sample of the reference block is determined according to the width of the reference block and the top neighbouring sample of the reference block.
Example 1, a reconstructed sample(s) which is neighbouring the top of the reference block in the reference picture and is within the width range of the reference block is determined as the i^{th} neighbouring reconstructed sample of the reference block. For example, if the width of the reference block is 4, 4 reconstructed samples neighbouring the top of top of the reference block in the reference picture are determined as the i^{th} neighbouring reconstructed sample of the reference block.
Example 2, if the width of the reference block is equal to a first value, interpolation is performed on the top neighbouring samples of the reference block to obtain samples, of which the quantity is the first value, as the i^{th} neighbouring reconstructed sample of the reference block.

There is no limitation on the specific value of the first value in embodiments of the disclosure.

Optionally, the first value is 4. That is, if the width of the reference block is equal to 4, the decoder performs interpolation on top neighbouring samples of the reference block to obtain 4 samples, and the 4 samples are determined as the i^{th} neighbouring reconstructed sample of the reference block.

Example 2, if the width of the reference block is not equal to the first value, interpolation interpolation is performed on the top neighbouring samples of the reference block to obtain samples, of which the quantity is a second value, as the i^{th} neighbouring reconstructed sample of the reference block.

For example, assuming that the width of the reference block is 32, the second value is determined to be 5. Then at the encoding end, interpolation is performed on 16 top neighbouring samples of the reference block to obtain 5 samples as the i^{th} neighbouring reconstructed sample of the reference block.

In the embodiment of the disclosure, if the i^{th} candidate mode is the top reconstructed sample mode, the i^{th} neighbouring reconstructed sample of the current block and the i^{th} neighbouring reconstructed sample of the reference block are determined in any of the foregoing manners, where the i^{th} neighbouring reconstructed sample of the current block depends only on the top neighbouring sample of the current block, and the Ah neighbouring reconstructed sample of the reference block depends only on the top neighbouring sample of the reference block.

At the encoding end, after determining the 7th neighbouring reconstructed sample of the current block and the i^{th} neighbouring reconstructed sample of the reference block according to the foregoing method, the following S702-A2 is performed.

S702-A2, an i^{th} linear transform parameter is determined according to the i^{th} neighbouring reconstructed sample of the current block and the i^{th} neighbouring reconstructed sample of the reference block.

In embodiments of the disclosure, there is no limitation on the manner for determining the i^{th} linear transform parameter according to the i^{th} neighbouring reconstructed sample of the current block and the i^{th} neighbouring reconstructed sample of the reference block.

In some embodiments, if the i^{th} linear transform parameter includes an i^{th} scaling factor and an i^{th} offset parameter, the step of determining the i^{th} linear transform parameter according to th neighbouring reconstructed sample of the current block and the Ah neighbouring reconstructed sample of the reference block in S702-A2 includes the following steps.

S702-A21, the i^{th} scaling factor is determined according to the i^{th} neighbouring reconstructed sample of the current block and the i^{th} neighbouring reconstructed sample of the reference block.

S702-A22, the i^{th} offset parameter is determined according to the i^{th} neighbouring reconstructed sample of the current block, the i^{th} neighbouring reconstructed sample of the reference block, and the i^{th} scaling factor.

In embodiments of the disclosure, there is no limitation on the manner for determining the i^{th} scaling factor a according to the i^{th} neighbouring reconstructed sample of the current block and the i^{th} neighbouring reconstructed sample of the reference block in S702-A21.

In a possible implementation, the i^{th} scaling factor a is determined to be a ratio of the i^{th} neighbouring reconstructed sample of the current block to the i^{th} neighbouring reconstructed sample of the reference block.

In another possible implementation, the h scaling factor a is determined according to the foregoing formula (3).

In embodiments of the disclosure, there is no limitation on the manner for determining the i^{th} offset parameter according to the i^{th} neighbouring reconstructed sample of the current block, the i^{th} neighbouring reconstructed sample of the reference block, and the i^{th} scaling factor in S702-A22.

In a possible implementation, the i^{th} offset parameter b is determined according to the foregoing formula (4).

S702-A3, the first prediction value of the current block is determined, and linear transformation is performed on the first prediction value according to the i^{th} linear transform parameter to obtain a second prediction value corresponding to the i^{th} candidate mode.

After the i^{th} linear transform parameter is determined according to the foregoing method, linear transformation is performed on the first prediction value by using the i^{th} linear transform parameter, so as to obtain the second prediction value of the current block corresponding to the i^{th} candidate mode. For example, a product of the i^{th} scaling factor and the first prediction value is determined, and a sum of the product and the i^{th} offset parameter is determined as the second prediction value corresponding to the i^{th} candidate mode.

In an example, the second prediction value in the i^{th} candidate mode is determined according to the above formula (5).

S702-A4, a cost corresponding to the i^{th} candidate mode is determined according to the second prediction value corresponding to the i^{th} candidate mode.

Exemplarily, the cost corresponding to the i^{th} candidate mode is determined according to the second prediction value corresponding to the i^{th} candidate mode and the current block.

For example, a difference between the second prediction value corresponding to the i^{th} candidate mode and an original value corresponding to the current block is calculated to obtain a residual of the current block. A rate-distortion optimization (RDO) cost is calculated through operations such as transformation and quantization, and is denoted by costi.

In order to reduce complexity of cost calculation, the cost corresponding to the i^{th} candidate mode can also be determined by means of, for example, sum of absolute difference (SAD) or sum of absolute transformed difference (STAD).

According to the foregoing method, the cost corresponding to each of the N candidate modes can be determined, and then the foregoing S702-B is performed to determine the reconstructed sample mode for the current block from the N candidate modes according to the cost corresponding to each of the N candidate modes.

In an example, a candidate mode with a minimum cost among the N candidate modes is determined as the reconstructed sample mode for the current block.

In some embodiments, at the encoding end, after determining the reconstructed sample mode for the current block from the N candidate modes according to the cost corresponding to each of the N candidate modes, a first index is signalled into a bitstream, where the first index indicates the reconstructed sample mode for the current block.

In some embodiments, if the prediction mode for the current block is a Merge mode, at the encoding end, the reconstructed sample mode for the current block can also be determined in the following manner. That is, the foregoing step S702 includes the following steps S702-C1 and S702-C2.

S702-C1, a first flag of a neighbouring block of the current block is determined, where the first flag of the neighbouring block indicates whether the neighbouring block uses an illumination compensation technology.

S702-C2, the reconstructed sample mode for the current block is determined according to the first flag of the neighbouring block.

In the embodiments, at the encoding end, when performing illumination compensation on the current block, if the prediction mode for the current block is the Merge mode, whether the current block uses the illumination compensation technology provided in embodiments of the disclosure is determined according to whether the neighbouring block of the current block uses the illumination compensation technology. For example, if the neighbouring block uses the illumination compensation technology provided in embodiments of the disclosure, it is determined that the current block also uses the illumination compensation technology provided in embodiments of the disclosure.

Based on this, at the encoding end, the first flag is obtained from the neighbouring block, and the reconstructed sample mode for the current block is determined according to the first flag of the neighbouring block.

The manner for determining the reconstructed sample mode for the current block according to the first flag of the neighbouring block in S702-C2 includes, but is not limited to, the following manners.
Manner 1: if the first flag of the neighbouring block indicates that the neighbouring block uses the illumination compensation technology, it is determined that the reconstructed sample mode for the current block is the top-and-left reconstructed sample mode.

In manner 1, if the prediction mode for the current block is the Merge mode and the neighbouring block of the current block uses the illumination compensation technology, at the encoding end, it is determined by default that the reconstructed sample mode for the current block is the top-and-left reconstructed sample mode, and then illumination compensation is performed on the first prediction value of the current block directly by using the top-and-left reconstructed sample mode, so as to obtain the second prediction value of the current block.
Manner 2: if the first flag of the neighbouring block indicates that the neighbouring block uses the illumination compensation technology, a reconstructed sample mode for the neighbouring block is determined; and the reconstructed sample mode for the neighbouring block is determined as the reconstructed sample mode for the current block.

In manner 2, if the prediction mode for the current block is the Merge mode and the neighbouring block of the current block uses the illumination compensation technology, at the encoding end, the reconstructed sample mode for the neighbouring block of the current block is determined as the reconstructed sample mode for the current block. Specifically, at the encoding end, the reconstructed sample mode for the neighbouring block is obtained from the neighbouring block, and illumination compensation is performed on the first prediction value of the current block by using the reconstructed sample mode for the neighbouring block, so as to obtain the second prediction value.

The manner for determining the reconstructed sample mode for the neighbouring block of the current block at the encoding end at least includes the following several examples.
Example 1, at the encoding end, the reconstructed sample mode for the neighbouring block is obtained directly from the neighbouring block.
Example 2, at the encoding end, a second index is obtained from the neighbouring block, where the second index indicates the reconstructed sample mode for the neighbouring block. In this way, at the encoding end, the reconstructed sample mode for the neighbouring block is determined according to the second index. For example, as illustrated in table 1, if the second index is 0, it is determined that the reconstructed sample mode for the neighbouring block is the top reconstructed sample mode.

In manner 2, if prediction is performed on the current block by using the Merge mode, at the encoding end, the reconstructed sample mode for the current block is determined directly according to the first flag of the neighbouring block of the current block and/or the first index.

At the encoding end, after determining the reconstructed sample mode for the current block according to the foregoing method, the following step S703 is performed.

S703, the second prediction value of the current block is determined according to the reconstructed sample mode for the current block, where the second prediction value is obtained by performing illumination compensation on the first prediction value based on the reconstructed sample mode for the current block.

In some embodiments, at the encoding end, if the second prediction value corresponding to each of the N candidate modes is determined according to the foregoing S702-A and S702-B and the reconstructed sample mode for the current block is selected from the N candidate modes, a second prediction value corresponding to the reconstructed sample mode for the current block is determined directly as the second prediction value of the current block, and illumination compensation calculation does not need to be performed.

In some embodiments, at the encoding end, if the reconstructed sample mode for the current block is determined according to steps S702-C1 and S702-C2, that is, the first flag of the neighbouring block of the current block is determined and the reconstructed sample mode for the current block is determined according to the first flag of the neighbouring block, then S703 includes the following steps.

S703-A1, a neighbouring reconstructed sample of the current block and a neighbouring reconstructed sample of a reference block are determined according to the reconstructed sample mode for the current block.

S703-A2, a linear transform parameter is determined according to the neighbouring reconstructed sample of the current block and the neighbouring reconstructed sample of the reference block, and linear transformation is performed on the first prediction value according to the linear transform parameter to obtain the second prediction value of the current block.

For the implementation of S703-A1, reference is made to the illustration of S702-A1, which will not be described in detail again herein.

For the implementation of S703-A2, reference is made to the illustration of S702-A2 and S702-A3, which will not be described in detail again herein.

In embodiments of the disclosure, at the encoding end, the reconstructed sample mode for the current block is selected from the top reconstructed sample mode, the left reconstructed sample mode, and the top-and-left reconstructed sample mode. In this way, the mode for reconstructed sample selection is diversified, and on the other hand, it is possible to determine accurately a reconstructed sample mode adapted to characteristic information of the current block from various modes described above. As such, based on an accurate reconstructed sample mode, the neighbouring reconstructed sample of the current block and the neighbouring reconstructed sample of the reference block can be determined more accurately, then the linear transform parameter is determined based on the neighbouring reconstructed sample of the current block and the neighbouring reconstructed sample of the reference block, and linear transformation is performed on the first prediction value of the current block according to the linear transform parameter to obtain an accurate second prediction value, which can improve effect of illumination compensation on the current block, thereby improving prediction effect on the current block.

In some embodiments, whether to use an extended illumination compensation technology in embodiments of the disclosure is defined by a flag. That is, at the encoding end, before step S702, a first flag of the current block is firstly determined, where the first flag of the current block indicates whether the current block uses the illumination compensation technology.

In some embodiments of the disclosure, at the encoding end, the first flag of the current block is determined, and the first flag is signalled into the bitstream.

In some embodiments, if the first flag of the current block indicates that the current block uses the illumination compensation technology, at the encoding end, a second flag of the current block is determined, and the second flag is signalled into the bitstream, where the second flag of the current block indicates whether the current block uses an extended illumination compensation technology.

In some embodiments, if the second flag of the current block indicates that the current block uses the extended illumination compensation technology, at the encoding end, an index of the reconstructed sample mode for the current block is signalled into the bitstream.

Exemplarily, if the first flag of the current block is 1, it indicates that the current block uses the illumination compensation technology; and if the first flag of the current block is 0, it indicates that the current block does not use the illumination compensation technology.

If the first flag of the current block indicates that the current block does not use the illumination compensation technology, for example, the first flag of the current block is 0, at the decoding end, the first prediction value is determined as the second prediction value, or the first prediction value is processed in other manners to obtain the second prediction value.

If the first flag of the current block indicates that the current block uses the illumination compensation technology, for example, the first flag of the current block is 1, at the decoding end, the second flag of the current block is determined, where the second flag of the current block indicates whether the current block uses the extended illumination compensation technology of the disclosure.

Exemplarily, if the second flag of the current block is 1, it indicates that the current block uses the extended illumination compensation technology; and if the second flag of the current block is 0, it indicates that the current block does not use the extended illumination compensation technology.

If the second flag of the current block indicates that the current block does not use the extended illumination compensation technology, for example, the second flag of the current block is 0, at the decoding end, a default reconstructed sample mode can be used, for example, the top-and-left reconstructed sample mode can be selected to perform illumination compensation on the first prediction value of the current block, so as to obtain the second prediction value.

In some embodiments, if the second flag of the current block indicates that the current block uses the extended illumination compensation technology of the disclosure, at the encoding end, the index of the reconstructed sample mode for the current block is signalled into the bitstream.

The manner for determining the first flag of the current block at the encoding end at least includes the following manners.
Manner 1: the first flag of the current block is obtained from a configuration file.

In manner 1, at the encoding end, the first flag of the current block is signalled into the bitstream, and at the decoding end, the first flag of the current block can be obtained directly by decoding.
Manner 2: if the prediction mode for the current block is the Merge mode, at the encoding end, the first flag of the neighbouring block of the current block is determined, where the first flag of the neighbouring block indicates whether the neighbouring block uses the illumination compensation technology, and then the first flag of the current block is determined according to the first flag of the neighbouring block. For example, at the encoding end, the first flag is obtained from the neighbouring block. If the value of the first flag of the neighbouring block is 1, it is determined that the value of the first flag of the current block is also 1, that is, if the first flag of the neighbouring block indicates that the neighbouring block uses the illumination compensation technology, it is determined that the current block also uses the illumination compensation technology. If the value of the first flag of the neighbouring block is 0, it is determined that the value of the first flag of the current block is also 0, that is, if the first flag of the neighbouring block indicates that the neighbouring block does not use the illumination compensation technology, it is determined that the current block also does not use the illumination compensation technology.

The manner for determining the second flag of the current block at the encoding end at least includes the following.
Manner 1: the second flag of the current block is obtained from the configuration file.

In manner 1, at the encoding end, the second flag of the current block is signalled into the bitstream, and at the decoding end, the second flag of the current block can be obtained directly by decoding.
Manner 2: if the prediction mode for the current block is the Merge mode, at the encoding end, a second flag of the neighbouring block of the current block is determined, where the second flag of the neighbouring block indicates whether the neighbouring block uses the extended illumination compensation technology of the disclosure, and then the second flag of the current block is determined according to the second flag of the neighbouring block. For example, at the encoding end, the second flag of the neighbouring block is obtained from the neighbouring block. If the value of the second flag of the neighbouring block is 1, it is determined that the value of the second flag of the current block is also 1, that is, if the second flag of the neighbouring block indicates that the neighbouring block uses the extended illumination compensation technology of the disclosure, it is determined that the current block also uses the extended illumination compensation technology of the disclosure. If the value of the second flag of the neighbouring block is 0, it is determined that the value of the second flag of the current block is also 0, that is, if the second flag of the neighbouring block indicates that the neighbouring block does not use the extended illumination compensation technology of the disclosure, it is determined that the current block also does not use the extended illumination compensation technology of the disclosure.

In some embodiments, the first flag includes at least one of: a sequence-level flag, a picture-level flag, or a block-level flag.

In some embodiments, at the encoding end, the illumination compensation technology of the disclosure is compared with other prediction modes. For example, the cost corresponding to each of the N candidate modes is determined according to the foregoing method, and a cost corresponding to another preset prediction mode(s) is calculated. Exemplarily, taking N=3 as an example, according to the foregoing method, a cost corresponding to the top reconstructed sample mode is determined and is denoted by cost1, a cost corresponding to the left reconstructed sample mode is determined and is denoted by cost2, and a cost corresponding to the top-and-left reconstructed sample mode is determined and is denoted by cost3. cost1, cost2, and cost3 are compared to determine the minimum cost value, which is denoted by costMin. Further, information related to the current illumination compensation mode is saved, which includes an illumination compensation mode index, where a mode index corresponding to cost1 is 0, a mode index corresponding to cost2 is 1, and a mode index corresponding to cost3 is 2.

Then, at the encoding end, other inter prediction technologies are traversed, rate-distortion cost values corresponding to these technologies are calculated, and a prediction mode corresponding to the minimum cost value is selected as the optimal prediction mode for a current CU.

If the illumination compensation technology is enabled for the current block and costMin is the minimum value, the current block uses the illumination compensation technology, and a CU-level usage flag bit for the illumination compensation technology, such as lic_flag, needs to be set to “true” and signalled into the bitstream. If an index corresponding to costMin is greater than 0, an extended illumination compensation mode flag bit, i.e. the second flag such as lic_ext of the current block, is set to “true” and signalled into the bitstream, and the index corresponding to costMin is signalled into the bitstream by means of equiprobable encoding; otherwise, the extended illumination compensation mode flag bit, that is, the second flag of the current block, is set to “false” and signalled into the bitstream.

If the illumination compensation technology is enabled for the current block but costMin is not the minimum value, the current block does not use the illumination compensation technology, and the CU-level illumination compensation technology usage flag bit, such as lic_flag, needs to be set to “false” and signalled into the bitstream.

If the illumination compensation technology is not enabled for the current block, information related to the optimal prediction mode among other non-illumination compensation technologies is signalled into the bitstream.

In some embodiments, if a current picture that the current block belongs to is a first-type picture, the extended illumination compensation technology provided in embodiments of the disclosure is implemented, that is, the foregoing S702 is performed to determine the reconstructed sample mode for the current block.

The type of the first-type picture is not limited in embodiments of the disclosure.

Optionally, if the first-type picture is a B frame, that is, the current picture is a B frame, the extended illumination compensation technology provided in the disclosure is enabled by default.

In some embodiments, if the area of the current block is greater than or equal to a preset threshold, the extended illumination compensation technology provided in embodiments of the disclosure is implemented, that is, the foregoing S702 is performed to determine the reconstructed sample mode for the current block.

There is no limitation on the value of the preset threshold in the disclosure.

Optionally, the preset threshold is 64, that is, the area of the current block is greater than or equal to the preset threshold, and then the extended illumination compensation technology provided in embodiments of the disclosure is implemented, that is, the foregoing S402 is performed to determine the reconstructed sample mode for the current block.

At the encoding end, after determining the prediction value of the current block, such as determining the second prediction value of the current block, according to the foregoing steps, a difference between a prediction block of the current block and the current block is calculated to obtain a residual value of the current block, transformation is performed on the residual value to obtain a transformed coefficient, the transformed coefficient is quantized to obtain a quantized coefficient, and the quantized coefficient is encoded to obtain the bitstream.

Further, after the first embodiment of the solutions is applied to the latest ECM 3.1, test results under common test conditions for random access (RA) and low-delay B (LDB) are illustrated in table 3.

TABLE 3

| | Random Access Main10 | | | | |
|---|---|---|---|---|---|
| | Over ECM3.1 | | | | |
| | Y | U | V | EncT | DecT |
| Class A1 | −0.07% | −0.15% | −0.16% | 119% | 102% |
| Class A2 | −0.11% | 0.01% | 0.02% | 118% | 100% |
| Class B | −0.06% | −0.08% | −0.01% | 117% | 105% |
| Class C | −0.05% | −0.05% | −0.04% | 118% | 112% |
| Class E | | | | | |
| Overall | −0.07% | −0.07% | −0.04% | 118% | 105% |

As can be seen from table 3, the extended illumination compensation technology provided in embodiments of the disclosure has improvement in performance for all sequence classes under RA and LDB. The improvement for 4K A2 sequences under the test condition for RA is the most significant, and there is a Bjøntegaard-delta (BD)-bitrate saving of 0.11% on average. In addition, the overall performance is improved, which proves effectiveness of the technology and improvement of encoding efficiency of the existing ECM reference software. It should be noted that, due to load of a server, the encoding/decoding time is not accurate, and theoretically, the decoding time does not change; and this experiment result is subject to no optimization at the encoding end. In addition, in this method, no extra burden is imposed at the decoding end, which will not increase complexity of hardware implementation.

According to the video encoding method provided in embodiments of the disclosure, at the encoding end, prediction is performed on the current block to obtain the first prediction value of the current block; the reconstructed sample mode for current block is determined, where the reconstructed sample mode is one of N candidate modes, and the N candidate modes include at least one of the top reconstructed sample mode, the left reconstructed sample mode, or the top-and-left reconstructed sample mode; and the second prediction value of the current block is determined according to the reconstructed sample mode for the current block, where the second prediction value is obtained by performing illumination compensation on the first prediction value based on the reconstructed sample mode for the current block. In embodiments of the disclosure, the reconstructed sample mode for the current block can be one of the top reconstructed sample mode, the left reconstructed sample mode, or the top-and-left reconstructed sample mode. In this way, the mode for reconstructed sample selection is diversified, and on the other hand, it is possible to determine accurately a reconstructed sample mode adapted to characteristic information of the current block from various modes described above. As such, based on an accurate reconstructed sample mode, the neighbouring reconstructed sample of the current block and the neighbouring reconstructed sample of the reference block can be determined more accurately, then the linear transform parameter is determined based on the neighbouring reconstructed sample of the current block and the neighbouring reconstructed sample of the reference block that are determined accurately, and linear transformation is performed on the first prediction value of the current block according to the linear transform parameter to obtain an accurate second prediction value, which can improve effect of illumination compensation on the current block, thereby improving prediction effect on the current block.

It should be understood that, FIG. 7 to FIG. 10 are merely examples of the disclosure, and should not be construed as limitation on the disclosure.

Preferable embodiments of the disclosure have been described in detail above with reference to the accompanying drawings. However, the disclosure is not limited to the details described in the foregoing embodiments. Within the scope of the technical concept of the disclosure, various simple modifications can be made to the technical solutions of the disclosure, and these simple modifications all fall within the protection scope of the disclosure. For example, various technical features described in the foregoing implementations can be combined in any suitable manner without contradiction, and in order to avoid unnecessary redundancy, various possible combinations are not further described in the disclosure. For another example, various embodiments of the disclosure can also be combined in any manner, and as long as the combinations do not depart from the idea of the disclosure, they should also be considered as contents disclosed in the disclosure.

It should also be understood that, in various method embodiments of the disclosure, the magnitude of a sequence number of each of the foregoing processes does not mean an execution order, and an execution order of each process should be determined according to a function and an internal logic of the process, which shall not constitute any limitation to the implementation of embodiments of the disclosure. In addition, in embodiments of the disclosure, the term “and/or” herein only describes an association between associated objects, which means that there can be three relationships. For example, A and/or B can mean A alone, both A and B exist, and B alone. In addition, the character “/” herein generally indicates that the associated objects are in an “or” relationship.

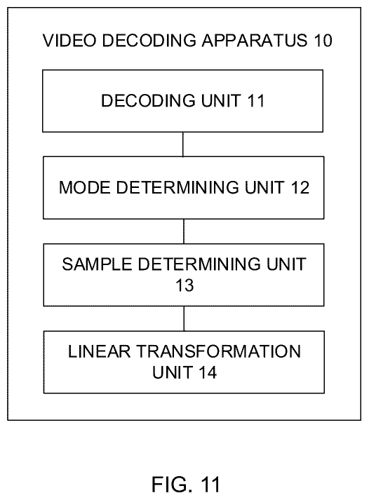

The method embodiments of the disclosure are described in detail with reference to FIG. 7 to FIG. 10, and apparatus embodiments of the disclosure will be described in detail below with reference to FIG. 11 to FIG. 14.

FIG. 11 is a schematic block diagram of a video decoding apparatus provided in embodiments of the disclosure.

As illustrated in FIG. 11, the video decoding apparatus 10 includes a decoding unit 11, a mode determining unit 12, a sample determining unit 13, and a linear transformation unit 14. The decoding unit 11 is configured to decode a bitstream, and perform prediction on a current block to obtain a first prediction value. The mode determining unit 12 is configured to determine a reconstructed sample mode for the current block, where the reconstructed sample mode is one of N candidate modes, and the N candidate modes include at least one of a top reconstructed sample mode, a left reconstructed sample mode, or a top-and-left reconstructed sample mode. The sample determining unit 13 is configured to determine a neighbouring reconstructed sample of the current block and a neighbouring reconstructed sample of a reference block according to the reconstructed sample mode for the current block. The linear transformation unit 14 is configured to determine a linear transform parameter according to the neighbouring reconstructed sample of the current block and the neighbouring reconstructed sample of the reference block, and perform linear transformation on the first prediction value according to the linear transform parameter to obtain a second prediction value of the current block.

In some embodiments, the mode determining unit 12 is specifically configured to determine a first index, where the first index indicates the reconstructed sample mode for the current block; and determine the reconstructed sample mode for the current block according to the first index.

In some embodiments, the mode determining unit 12 is specifically configured to obtain the first index by decoding the bitstream.

In some embodiments, a prediction mode for the current block is a Merge mode, and the mode determining unit 12 is specifically configured to: determine a first flag of a neighbouring block of the current block, where the first flag of the neighbouring block indicates whether the neighbouring block uses an illumination compensation technology; and determine the first index according to the first flag of the neighbouring block.

In some embodiments, the mode determining unit 12 is specifically configured to determine the first index to be a default index if the first flag of the neighbouring block indicates that the neighbouring block uses the illumination compensation technology, where the default index indicates the top-and-left reconstructed sample mode.

In some embodiments, the mode determining unit 12 is specifically configured to: determine a second index when the first flag of the neighbouring block indicates that the neighbouring block uses the illumination compensation technology, where the second index indicates a reconstructed sample mode for the neighbouring block; determine the second index as the first index.

In some embodiments, a prediction mode for the current block is a non-Merge mode, and the mode determining unit 12 is specifically configured to: determine a first flag of the current block, where the first flag of the current block indicates whether the current block uses an illumination compensation technology; determine a second flag of the current block if the first flag of the current block indicates that the current block uses the illumination compensation technology, where the second flag of the current block indicates whether the current block uses an extended illumination compensation technology; and determine the first index according to the second flag of the current block.

In some embodiments, the mode determining unit 12 is specifically configured to obtain the first index by decoding the bitstream if the second flag of the current block indicates that the current block uses the extended illumination compensation technology.

In some embodiments, the mode determining unit 12 is specifically configured to: determine the first index to be a default index if the second flag of the current block indicates that the current block does not use the extended illumination compensation technology, where the default index indicates the top-and-left reconstructed sample mode.

In some embodiments, the mode determining unit 12 is specifically configured to obtain the first flag of the current block by decoding the bitstream.

In some embodiments, the mode determining unit 12 is specifically configured to obtain the second flag of the current block by decoding the bitstream.

In some embodiments, a prediction mode for the current block is a Merge mode, and the mode determining unit 12 is specifically configured to: determine a first flag of a neighbouring block of the current block, where the first flag of the neighbouring block indicates whether the neighbouring block uses an illumination compensation technology; and determine the reconstructed sample mode for the current block according to the first flag of the neighbouring block.

In some embodiments, the mode determining unit 12 is specifically configured to determine that the reconstructed sample mode for the current block is the top-and-left reconstructed sample mode, if the first flag of the neighbouring block indicates that the neighbouring block uses the illumination compensation technology.

In some embodiments, the mode determining unit 12 is specifically configured to: determine a reconstructed sample mode for the neighbouring block if the first flag of the neighbouring block indicates that the neighbouring block uses the illumination compensation technology; determine the reconstructed sample mode for the neighbouring block as the reconstructed sample mode for the current block.

In some embodiments, the mode determining unit 12 is specifically configured to: determine a second index, where the second index indicates the reconstructed sample mode for the neighbouring block; and determine the reconstructed sample mode for the neighbouring block according to the second index.

In some embodiments, the sample determining unit 13 is specifically configured to: determine the neighbouring reconstructed sample of the current block according to a left neighbouring sample of the current block and determine a neighbouring reconstructed sample of a reference block corresponding to the current block in a reference picture according to a left neighbouring sample of the reference block, if the reconstructed sample mode for the current block is the left reconstructed sample mode.

In some embodiments, the sample determining unit 13 is specifically configured to determine the neighbouring reconstructed sample of the current block according to a height of the current block and the left neighbouring sample of the current block.

In some embodiments, the sample determining unit 13 is specifically configured to select samples, the number of which is a first value, from the left neighbouring samples of the current block as the neighbouring reconstructed samples of the current block, if the height of the current block is equal to the first value.

In some embodiments, the sample determining unit 13 is specifically configured to select samples, the number of which is a second value, from the left neighbouring samples of the current block as the neighbouring reconstructed samples of the current block, if the height of the current block is not equal to the first value.

In some embodiments, the sample determining unit 13 is specifically configured to determine the neighbouring reconstructed sample of the reference block according to a height of the reference block and the left neighbouring sample of the reference block.

In some embodiments, the sample determining unit 13 is specifically configured to perform interpolation on the left neighbouring samples of the reference block to obtain samples, the number of which is a first value, as the neighbouring reconstructed samples of the reference block, if the height of the reference block is equal to the first value.

In some embodiments, the sample determining unit 13 is specifically configured to perform interpolation on the left neighbouring samples of the reference block to obtain samples, the number of which is a second value, as the neighbouring reconstructed samples of the reference block, if the height of the reference block is not equal to the first value.

In some embodiments, the sample determining unit 13 is specifically configured to determine the neighbouring reconstructed sample of the current block according to a top neighbouring sample of the current block and determine a neighbouring reconstructed sample of a reference block corresponding to the current block in a reference picture according to a top neighbouring sample of the reference block, if the reconstructed sample mode for the current block is the top reconstructed sample mode.

In some embodiments, the sample determining unit 13 is specifically configured to determine the neighbouring reconstructed sample of the current block according to a width of the current block and the top neighbouring sample of the current block.

In some embodiments, the sample determining unit 13 is specifically configured to select samples, the number of which is a first value, from the top neighbouring samples of the current block as the neighbouring reconstructed samples of the current block, if the width of the current block is equal to the first value.

In some embodiments, the sample determining unit 13 is configured to select samples, the number of which is a second value, from the top neighbouring samples of the current block as the neighbouring reconstructed samples of the current block, if the width of the current block is not equal to the first value.

In some embodiments, the sample determining unit 13 is specifically configured to determine the neighbouring reconstructed sample of the reference block according to a width of the reference block and the top neighbouring sample of the reference block.

In some embodiments, the sample determining unit 13 is specifically configured to perform interpolation on the top neighbouring samples of the reference block to obtain samples, the number of which is a first value, as the neighbouring reconstructed samples of the reference block, if the width of the reference block is equal to the first value.

In some embodiments, the width of the reference block is not equal to the first value, and the sample determining unit 13 is specifically configured to perform interpolation on the top neighbouring samples of the reference block to obtain samples, the number of which is a second value, and determine the neighbouring reconstructed sample of the reference block based on the samples, the number of which is the second value, obtained by means of interpolation.

Optionally, the first flag includes at least one of: a sequence-level flag, a picture-level flag, or a block-level flag.

In some embodiments, the linear transform parameter includes a scaling factor and an offset parameter, and the linear transformation unit 14 is configured to: determine the scaling factor according to the neighbouring reconstructed sample of the current block and the neighbouring reconstructed sample of the reference block; and determine the offset parameter according to the neighbouring reconstructed sample of the current block, the neighbouring reconstructed sample of the reference block, and the scaling factor.

In some embodiments, the linear transformation unit 14 is configured to perform linear transformation on the first prediction value according to the scaling factor and the offset parameter, to obtain the second prediction value of the current block.

In some embodiments, the linear transformation unit 14 is configured to: determine a product of the scaling factor and the first prediction value; and determine a sum of the product and the offset parameter as the second prediction value.

In some embodiments, the mode determining unit 12 is specifically configured to determine the reconstructed sample mode for the current block if a current picture that the current block belongs to is a first-type picture.

In some embodiments, the mode determining unit 12 is configured to determine the reconstructed sample mode for the current block if the area of the current block is greater than or equal to a preset threshold.

It should be understood that, the apparatus embodiments and the method embodiments can correspond to each other, and for similar elaboration, reference can be made to the method embodiments, which are not elaborated again herein to avoid repetition. Specifically, the video decoding apparatus 10 illustrated in FIG. 11 can correspond to a corresponding entity for implementing the method in embodiments of the disclosure, and the foregoing and other operations and/or functions of various units in the video decoding apparatus 10 are respectively intended to implement corresponding processes in various methods, which are not elaborated again herein for the sake of brevity.

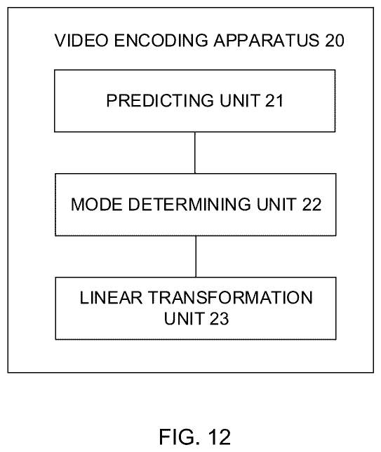

FIG. 12 is a schematic block diagram of a video encoding apparatus provided in embodiments of the disclosure.

As illustrated in FIG. 12, the video encoding apparatus 20 includes a predicting unit 21, a mode determining unit 22, and a linear transformation unit 23. The predicting unit 21 is configured to perform prediction on a current block to obtain a first prediction value of the current block. The mode determining unit 22 is configured to determine a reconstructed sample mode for the current block, where the reconstructed sample mode is one of N candidate modes, and the N candidate modes comprise at least one of a top reconstructed sample mode, a left reconstructed sample mode, or a top-and-left reconstructed sample mode. The linear transformation unit 23 is configured to determine a second prediction value of the current block according to the reconstructed sample mode for the current block, where the second prediction value is obtained by performing illumination compensation on the first prediction value based on the reconstructed sample mode for the current block.

In some embodiments, the mode determining unit 22 is configured to: for an i^{th} candidate mode in the N candidate modes, determine a cost corresponding to the i^{th} candidate mode, where i is a positive integer and 1≤i≤N; and determine the reconstructed sample mode for the current block from the N candidate modes according to costs corresponding to the N candidate modes.

In some embodiments, the mode determining unit 22 is configured to: determine an i^{th} neighbouring reconstructed sample of the current block and an i^{th} neighbouring reconstructed sample of a reference block according to the i^{th} candidate mode; determine an i^{th} linear transform parameter according to the i^{th} neighbouring reconstructed sample of the current block and the i^{th} neighbouring reconstructed sample of the reference block; determine the first prediction value of the current block, and perform linear transformation on the first prediction value according to the i^{th} linear transform parameter to obtain a second prediction value corresponding to the i^{th} candidate mode; and determine the cost corresponding to the i^{th} candidate mode according to the second prediction value corresponding to the i^{th} candidate mode.

In some embodiments, the mode determining unit 22 is configured to: determine the i^{th} neighbouring reconstructed sample of the current block according to a left neighbouring sample of the current block and determine an i^{th} neighbouring reconstructed sample of a reference block corresponding to the current block in a reference picture according to a left neighbouring sample of the reference block, if the i^{th} candidate mode is the left reconstructed sample mode.

In some embodiments, the mode determining unit 22 is configured to determine the i^{th} neighbouring reconstructed sample of the current block according to a height of the current block and the left neighbouring sample of the current block.

In some embodiments, the mode determining unit 22 is configured to select samples, the number of which is a first value, from the left neighbouring samples of the current block as the i^{th} neighbouring reconstructed sample of the current block, if the height of the current block is equal to the first value.

In some embodiments, the mode determining unit 22 is configured to select samples, the number of which is a second value, from the left neighbouring samples of the current block as the i^{th} neighbouring reconstructed sample of the current block, if the height of the current block is not equal to the first value.

In some embodiments, the mode determining unit 22 is configured to determine the i^{th} neighbouring reconstructed sample of the reference block according to a height of the reference block and the left neighbouring sample of the reference block.

In some embodiments, if the height of the reference block is equal to the first value, the mode determining unit 22 is configured to perform interpolation on the left neighbouring samples of the reference block to obtain samples, the number of which is a first value, as the i^{th} neighbouring reconstructed sample of the reference block, if the height of the reference block is equal to the first value.

In some embodiments, the mode determining unit 22 is configured to perform interpolation on the left neighbouring samples of the reference block to obtain samples, the number of which is a second value, as the i^{th} neighbouring reconstructed sample of the reference block, if the height of the reference block is not equal to the first value.

In some embodiments, the mode determining unit 22 is configured to determine the i^{th} neighbouring reconstructed sample of the current block according to a top neighbouring sample of the current block and determine an i^{th} neighbouring reconstructed sample of a reference block corresponding to the current block in a reference picture according to a top neighbouring sample of the reference block, if the i^{th} candidate mode is the top reconstructed sample mode.

In some embodiments, the mode determining unit 22 is configured to determine the i^{th} neighbouring reconstructed sample of the current block according to a width of the current block and the top neighbouring sample of the current block.

In some embodiments, the mode determining unit 22 is configured to select samples, the number of which is a first value, from the top neighbouring samples of the current block as the i^{th} neighbouring reconstructed sample of the current block, if the width of the current block is equal to the first value.

In some embodiments, the mode determining unit 22 is configured to select samples, the number of which is a second value, from the top neighbouring samples of the current block as the i^{th} neighbouring reconstructed sample of the current block, if the width of the current block is not equal to a first value.

In some embodiments, the mode determining unit 22 is configured to determine the i^{th} neighbouring reconstructed sample of the reference block according to a width of the reference block and the top neighbouring sample of the reference block.

In some embodiments, the mode determining unit 22 is configured to perform interpolation on the top neighbouring samples of the reference block to obtain samples, the number of which is a first value, as the i^{th} neighbouring reconstructed sample of the reference block, if the width of the reference block is equal to the first value.

In some embodiments, the mode determining unit 22 is configured to perform interpolation on the top neighbouring samples of the reference block to obtain samples, the number of which is a second value, as the i^{th} neighbouring reconstructed sample of the reference block, if the width of the reference block is not equal to the first value.

In some embodiments, the i^{th} linear transform parameter includes an i^{th} scaling factor and an i^{th} offset parameter, and the mode determining unit 22 is configured to determine the i^{th} scaling factor according to the i^{th} neighbouring reconstructed sample of the current block and the i^{th} neighbouring reconstructed sample of the reference block; and determine the i^{th} offset parameter according to the i^{th} neighbouring reconstructed sample of the current block, the i^{th} neighbouring reconstructed sample of the reference block, and the i^{th} scaling factor.

In some embodiments, the mode determining unit 22 is configured to perform linear transformation on the first prediction value according to the i^{th} scaling factor and the i^{th} offset parameter to obtain the second prediction value corresponding to the i^{th} candidate mode.

In some embodiments, the mode determining unit 22 is configured to determine a product of the i^{th} scaling factor and the first prediction value; and determine a sum of the product and the i^{th} offset parameter as the second prediction value corresponding to the i^{th} candidate mode.

In some embodiments, the mode determining unit 22 is configured to determine the cost corresponding to the i^{th} candidate mode according to the second prediction value corresponding to the i^{th} candidate mode and the current block.

In some embodiments, the mode determining unit 22 is configured to determine a candidate mode with a minimum cost among the N candidate modes as the reconstructed sample mode for the current block.

In some embodiments, the linear transformation unit 23 is configured to determine a second prediction value corresponding to the reconstructed sample mode for the current block as the second prediction value of the current block.

In some embodiments, the linear transformation unit 23 is configured to signal a first index into a bitstream, where the first index indicates the reconstructed sample mode for the current block.

In some embodiments, a prediction mode for the current block is a Merge mode, and the mode determining unit 22 is configured to determine a first flag of a neighbouring block of the current block, where the first flag of the neighbouring block indicates whether the neighbouring block uses an illumination compensation technology; and determine the reconstructed sample mode for the current block according to the first flag of the neighbouring block.

In some embodiments, the mode determining unit 22 is configured to determine that the reconstructed sample mode for the current block is the top-and-left reconstructed sample mode, if the first flag of the neighbouring block indicates that the neighbouring block uses the illumination compensation technology.

In some embodiments, the mode determining unit 22 is configured to determine a reconstructed sample mode for the neighbouring block if the first flag of the neighbouring block indicates that the neighbouring block uses the illumination compensation technology; and determine the reconstructed sample mode for the neighbouring block as the reconstructed sample mode for the current block.

In some embodiments, the mode determining unit 22 is configured to determine a second index, where the second index indicates the reconstructed sample mode for the neighbouring block; and determine the reconstructed sample mode for the neighbouring block according to the second index.

In some embodiments, the mode determining unit 22 is configured to determine a neighbouring reconstructed sample of the current block and a neighbouring reconstructed sample of a reference block according to the reconstructed sample mode for the current block; and determine a linear transform parameter according to the neighbouring reconstructed sample of the current block and the neighbouring reconstructed sample of the reference block, and perform linear transformation on the first prediction value according to the linear transform parameter to obtain the second prediction value of the current block.

In some embodiments, the linear transformation unit 23 is configured to determine a first flag of the current block, and signal the first flag into a bitstream, where the first flag of the current block indicates whether the current block uses an illumination compensation technology.

In some embodiments, the linear transformation unit 23 is configured to determine a second flag of the current block and signal the second flag of the current block into the bitstream, if the first flag of the current block indicates that the current block uses the illumination compensation technology, where the second flag of the current block indicates whether the current block uses an extended illumination compensation technology.

In some embodiments, the linear transformation unit 23 is configured to signal an index of the reconstructed sample mode for the current block into the bitstream if the second flag of the current block indicates that the current block uses the extended illumination compensation technology.

In some embodiments, a prediction mode for the current block is a Merge mode, and the linear transformation unit 23 is configured to: determine a first flag of a neighbouring block of the current block, where the first flag of the neighbouring block indicates whether the neighbouring block uses the illumination compensation technology; and determine the first flag of the current block according to the first flag of the neighbouring block.

In some embodiments, the prediction mode for the current block is the Merge mode, and the linear transformation unit 23 is configured to: determine a second flag of the neighbouring block of the current block, where the second flag of the neighbouring block indicates whether the neighbouring block uses an extended illumination compensation technology; and determine the second flag of the current block according to the second flag of the neighbouring block.

Optionally, the first flag includes at least one of: a sequence-level flag, a picture-level flag, or a block-level flag.

In some embodiments, the mode determining unit 22 is configured to determine the reconstructed sample mode for the current block if a current picture that the current block belongs to is a first-type picture.

In some embodiments, the mode determining unit 22 is configured to determine the reconstructed sample mode for the current block if the area of the current block is greater than or equal to a preset threshold.

It should be understood that, the apparatus embodiments and the method embodiments can correspond to each other, and for similar elaboration, reference can be made to the method embodiments, which are not elaborated again herein to avoid repetition. Specifically, the video encoding apparatus 20 illustrated in FIG. 12 can correspond to a corresponding entity for implementing the method in embodiments of the disclosure, and the foregoing and other operations and/or functions of various units in the video encoding apparatus 20 are respectively intended to implement corresponding processes in various methods, which are not elaborated again herein for the sake of brevity.

The apparatus and system in embodiments of the disclosure have been described above from the perspective of functional units with reference to the accompanying drawings. It should be understood that, the functional unit can be implemented in the form of hardware, or can be implemented by an instruction in the form of software, or can be implemented by a combination of hardware and software unit. Specifically, each step of the method embodiments of the disclosure can be completed by an integrated logic circuit of hardware in a processor and/or an instruction in the form of software. The steps of the method disclosed in embodiments of the disclosure can be directly implemented by a hardware decoding processor, or can be performed by hardware and software units in the decoding processor. Optionally, the software unit can be located in a storage medium such as a random access memory (RAM), a flash memory, a read only memory (ROM), a programmable ROM (PROM), or an electrically erasable programmable memory, registers, and the like. The storage medium is located in a memory. The processor reads the information in the memory, and completes the steps of the foregoing method embodiments with the hardware of the processor.

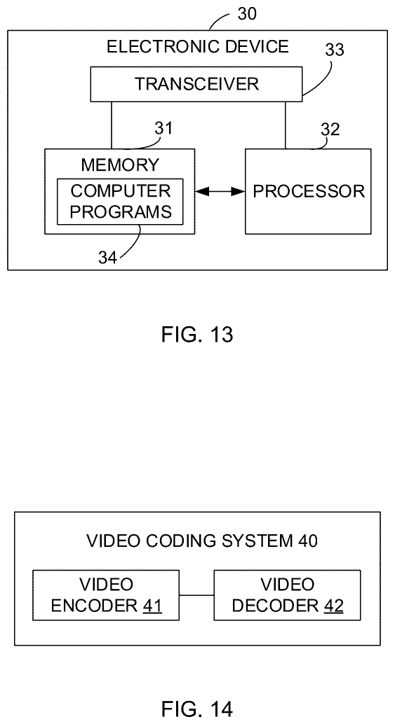

FIG. 13 is a schematic block diagram of an electronic device provided in embodiments of the disclosure.

As illustrated in FIG. 13, the electronic device 30 can be the video encoder or the video decoder described in embodiments of the disclosure. The electronic device 30 can include a memory 31, a processor 32, and a transceiver 33. The memory 31 is configured to store computer programs 34 and transmit program codes 34 to the processor 32. In other words, the processor 32 can invoke and execute the computer programs 34 stored in the memory 31 to implement the method in embodiments of the disclosure.

For example, the processor 32 can be configured to perform the steps of the method described above according to instructions in the computer programs 34.

In some embodiments of the disclosure, the processor 32 can include, but is not limited to: a general-purpose processor, a digital signal processor (DSP), an application specific integrated circuit (ASIC), a field programmable gate array (FPGA), or other programmable logic devices, discrete gates or transistor logic devices, discrete hardware components, etc.

In some embodiments of the disclosure, the memory 31 includes, but is not limited to: a volatile memory and/or a non-volatile memory. The non-volatile memory may be a ROM, a PROM, an erasable PROM (EPROM), an electrically EPROM (EEPROM), or flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM).

In some embodiments of the disclosure, the computer program 34 can be divided into one or more units, and the one or more units are stored in the memory 31 and configured to be executed by the processor 32 to complete the method provided in the disclosure. The one or more units can be a series of computer program instruction segments capable of performing a particular function, the instruction segments are used for describing the execution of the computer program 34 in the electronic device 30.

As illustrated in FIG. 13, the electronic device 30 can further include a transceiver 33. The transceiver 33 can be connected to the processor 32 or to the memory 31. The processor 32 can control the transceiver 33 to communicate with other devices, and specifically, can send information or data to other devices, or receive information or data sent by other devices. The transceiver 33 can further include an antenna, where the number of antennas can be one or multiple.

It should be understood that, various components in the electronic device 30 are connected via a bus system. In addition to a data bus, the bus system further includes a power bus, a control bus, and a state signal bus.

FIG. 14 is a schematic block diagram of a video coding system 40 provided in embodiments of the disclosure.

As illustrated in FIG. 14, the video coding system 40 can include a video encoder 41 and a video decoder 42. The video encoder 41 is configured to implement the video encoding method in embodiments of the disclosure, and the video decoder 42 is configured to implement the video decoding method in embodiments of the disclosure.

In some embodiments, the disclosure further provides a bitstream. The bitstream is obtained by means of the foregoing encoding method.

The disclosure further provides a computer storage medium. The computer storage medium is configured to store computer programs. The computer programs, when executed by a computer, are operable with the computer to implement the method in the foregoing method embodiments. In other words, embodiments of the disclosure further provide a computer program product. The computer program product includes instructions. The instructions, when executed by a computer, are operable with the computer to implement the method in the foregoing method embodiments.

When implemented by software, all or some the above embodiments can be implemented in the form of a computer program product. The computer program product includes one or more computer instructions. When the computer instructions are applied and executed on a computer, all or some the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

Those of ordinary skill in the art will appreciate that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art can use different methods with regard to each particular application to implement the described functionality, but such implementation should not be regarded as lying beyond the scope of the disclosure.

It will be appreciated that the systems, apparatuses, and methods disclosed in embodiments of the disclosure can also be implemented in various other manners. For example, the above apparatus embodiments are merely illustrative, e.g., the division of units is only a division of logical functions, and other manners of division can be available in practice, e.g., multiple units or assemblies can be combined or can be integrated into another system, or some features can be ignored or skipped. In other respects, the coupling or direct coupling or communication connection as illustrated or discussed can be an indirect coupling or communication connection through some interface, device, or unit, and can be electrical, mechanical, or otherwise.

Separated units as illustrated may or may not be physically separated. Components displayed as units may or may not be physical units, and can reside at one location or can be distributed to multiple networked units. Some or all of the units can be selectively adopted according to practical needs to achieve desired objectives of the solutions of embodiments. For example, various functional units described in various embodiments of the disclosure can be integrated into one processing unit or can be present as a number of physically separated units, and two or more units can be integrated into one.

A video decoding method, comprises: decoding a bitstream, and performing prediction on a current block to obtain a first prediction value; determining a reconstructed sample mode for the current block, wherein the reconstructed sample mode is one of N candidate modes, and the N candidate modes comprise at least one of a top reconstructed sample mode, a left reconstructed sample mode, or a top-and-left reconstructed sample mode; determining a neighbouring reconstructed sample of the current block and a neighbouring reconstructed sample of a reference block according to the reconstructed sample mode for the current block; and determining a linear transform parameter according to the neighbouring reconstructed sample of the current block and the neighbouring reconstructed sample of the reference block, and performing linear transformation on the first prediction value according to the linear transform parameter to obtain a second prediction value of the current block.

In some embodiments, determining the reconstructed sample mode for the current block comprises: determining a first index, wherein the first index indicates the reconstructed sample mode for the current block; and determining the reconstructed sample mode for the current block according to the first index.

In some embodiments, determining the first index comprises: obtaining the first index by decoding the bitstream.

In some embodiments, when a prediction mode for the current block is a Merge mode, determining the first index comprises: determining a first flag of a neighbouring block of the current block, wherein the first flag of the neighbouring block indicates whether the neighbouring block uses an illumination compensation technology; and determining the first index according to the first flag of the neighbouring block.

In some embodiments, determining the first index according to the first flag of the neighbouring block comprises: determining the first index to be a default index, when the first flag of the neighbouring block indicates that the neighbouring block uses the illumination compensation technology, wherein the default index indicates the top-and-left reconstructed sample mode.

In some embodiments, determining the first index according to the first flag of the neighbouring block comprises: determining a second index when the first flag of the neighbouring block indicates that the neighbouring block uses the illumination compensation technology, wherein the second index indicates a reconstructed sample mode for the neighbouring block; and determining the second index as the first index.

In some embodiments, when a prediction mode for the current block is a non-Merge mode, determining the first index comprises: determining a first flag of the current block, wherein the first flag of the current block indicates whether the current block uses an illumination compensation technology; determining a second flag of the current block when the first flag of the current block indicates that the current block uses the illumination compensation technology, wherein the second flag of the current block indicates whether the current block uses an extended illumination compensation technology; and determining the first index according to the second flag of the current block.

In some embodiment, determining the first index according to the second flag of the current block comprises: obtaining the first index by decoding the bitstream, when the second flag of the current block indicates that the current block uses the extended illumination compensation technology.

In some embodiments, determining the first index according to the second flag of the current block comprises: determining the first index to be a default index, when the second flag of the current block indicates that the current block does not use the extended illumination compensation technology, wherein the default index indicates the top-and-left reconstructed sample mode.

In some embodiments, determining the first flag of the current block comprises: obtaining the first flag of the current block by decoding the bitstream.

In some embodiments, determining the second flag of the current block comprises: obtaining the second flag of the current block by decoding the bitstream.

In some embodiments, wherein when a prediction mode for the current block is a Merge mode, determining the reconstructed sample mode for the current block comprises: determining a first flag of a neighbouring block of the current block, wherein the first flag of the neighbouring block indicates whether the neighbouring block uses an illumination compensation technology; and determining the reconstructed sample mode for the current block according to the first flag of the neighbouring block.

In some embodiments, wherein determining the reconstructed sample mode for the current block according to the first flag of the neighbouring block comprises: determining that the reconstructed sample mode for the current block is the top-and-left reconstructed sample mode, when the first flag of the neighbouring block indicates that the neighbouring block uses the illumination compensation technology.

In some embodiments, determining the reconstructed sample mode for the current block according to the first flag of the neighbouring block comprises: determining a reconstructed sample mode for the neighbouring block when the first flag of the neighbouring block indicates that the neighbouring block uses the illumination compensation technology; and determining the reconstructed sample mode for the neighbouring block as the reconstructed sample mode for the current block.

In some embodiments, determining the reconstructed sample mode for the neighbouring block comprises: determining a second index, wherein the second index indicates the reconstructed sample mode for the neighbouring block; and determining the reconstructed sample mode for the neighbouring block according to the second index.

In some embodiments, determining the neighbouring reconstructed sample of the current block and the neighbouring reconstructed sample of the reference block according to the reconstructed sample mode for the current block comprises: when the reconstructed sample mode for the current block is the left reconstructed sample mode, determining the neighbouring reconstructed sample of the current block according to a left neighbouring sample of the current block, and determining a neighbouring reconstructed sample of a reference block corresponding to the current block in a reference picture according to a left neighbouring sample of the reference block.

In some embodiments, determining the neighbouring reconstructed sample of the current block according to the left neighbouring sample of the current block comprises: determining the neighbouring reconstructed sample of the current block according to a height of the current block and the left neighbouring sample of the current block.

In some embodiment, determining the neighbouring reconstructed sample of the current block according to the height of the current block and the left neighbouring sample of the current block comprises: when the height of the current block is equal to a first value, selecting samples, the number of which is the first value, from the left neighbouring samples of the current block as the neighbouring reconstructed samples of the current block.

In some embodiments, the determining the neighbouring reconstructed sample of the current block according to the height of the current block and the left neighbouring sample of the current block comprises: when the height of the current block is not equal to a first value, selecting samples, the number of which is a second value, from the left neighbouring samples of the current block as the neighbouring reconstructed samples of the current block.

In some embodiments, determining the neighbouring reconstructed sample of the reference block corresponding to the current block in the reference picture according to the left neighbouring sample of the reference block comprises: determining the neighbouring reconstructed sample of the reference block according to a height of the reference block and the left neighbouring sample of the reference block.

In some embodiments, determining the neighbouring reconstructed sample of the reference block according to the height of the reference block and the left neighbouring sample of the reference block comprises: when the height of the reference block is equal to a first value, performing interpolation on the left neighbouring samples of the reference block to obtain samples, the number of which is the first value, as the neighbouring reconstructed samples of the reference block.

In some embodiments, determining the neighbouring reconstructed sample of the reference block according to the height of the reference block and the left neighbouring sample of the reference block comprises: when the height of the reference block is not equal to a first value, performing interpolation on the left neighbouring samples of the reference block to obtain samples, the number of which is a second value, as the neighbouring reconstructed samples of the reference block.

In some embodiments, determining the neighbouring reconstructed sample of the current block and the neighbouring reconstructed sample of the reference block according to the reconstructed sample mode for the current block comprises: when the reconstructed sample mode for the current block is the top reconstructed sample mode, determining the neighbouring reconstructed sample of the current block according to a top neighbouring sample of the current block, and determining a neighbouring reconstructed sample of a reference block corresponding to the current block in a reference picture according to a top neighbouring sample of the reference block.

In some embodiments, determining the neighbouring reconstructed sample of the current block according to the top neighbouring sample of the current block comprises: determining the neighbouring reconstructed sample of the current block according to a width of the current block and the top neighbouring sample of the current block.

In some embodiments, determining the neighbouring reconstructed sample of the current block according to the width of the current block and the top neighbouring sample of the current block comprises: when the width of the current block is equal to a first value, selecting samples, the number of which is the first value, from the top neighbouring samples of the current block as the neighbouring reconstructed samples of the current block.

In some embodiments, determining the neighbouring reconstructed sample of the current block according to the width of the current block and the top neighbouring sample of the current block comprises: when the width of the current block is not equal to a first value, selecting samples, the number of which is a second value, from the top neighbouring samples of the current block as the neighbouring reconstructed samples of the current block.

In some embodiments, determining the neighbouring reconstructed sample of the reference block corresponding to the current block in the reference picture according to the top neighbouring sample of the reference block comprises: determining the neighbouring reconstructed sample of the reference block according to a width of the reference block and the top neighbouring sample of the reference block.

In some embodiments, determining the neighbouring reconstructed sample of the reference block according to the width of the reference block and the top neighbouring sample of the reference block comprises: when the width of the reference block is equal to a first value, performing interpolation on the top neighbouring samples of the reference block to obtain samples, the number of which is the first value, as the neighbouring reconstructed samples of the reference block.

In some embodiments, determining the neighbouring reconstructed sample of the reference block according to the width of the reference block and the top neighbouring sample of the reference block comprises: when the width of the reference block is not equal to a first value, performing interpolation on the top neighbouring samples of the reference block to obtain samples, the number of which is a second value, and determining the neighbouring reconstructed sample of the reference block based on the samples, the number of which is the second value, obtained by means of interpolation.

In some embodiments, wherein the first flag comprises at least one of: a sequence-level flag, a picture-level flag, or a block-level flag.

In some embodiments, the linear transform parameter comprises a scaling factor and an offset parameter, and determining the linear transform parameter according to the neighbouring reconstructed sample of the current block and the neighbouring reconstructed sample of the reference block comprises: determining the scaling factor according to the neighbouring reconstructed sample of the current block and the neighbouring reconstructed sample of the reference block; and determining the offset parameter according to the neighbouring reconstructed sample of the current block, the neighbouring reconstructed sample of the reference block, and the scaling factor.

In some embodiments, performing linear transformation on the first prediction value according to the linear transform parameter to obtain the second prediction value of the current block comprises: performing linear transformation on the first prediction value according to the scaling factor and the offset parameter, to obtain the second prediction value of the current block.

In some embodiments, performing linear transformation on the first prediction value according to the scaling factor and the offset parameter to obtain the second prediction value of the current block comprises: determining a product of the scaling factor and the first prediction value; and determining a sum of the product and the offset parameter as the second prediction value.

In some embodiments, determining the reconstructed sample mode for the current block comprises: determining the reconstructed sample mode for the current block when a current picture that the current block belongs to is a first-type picture.

In some embodiments, determining the reconstructed sample mode for the current block comprises: determining the reconstructed sample mode for the current block when a size of the current block is greater than or equal to a preset threshold.

A video encoding method, comprises: performing prediction on a current block to obtain a first prediction value of the current block; determining a reconstructed sample mode for the current block, wherein the reconstructed sample mode is one of N candidate modes, and the N candidate modes comprise at least one of a top reconstructed sample mode, a left reconstructed sample mode, or a top-and-left reconstructed sample mode; and determining a second prediction value of the current block according to the reconstructed sample mode for the current block, wherein the second prediction value is obtained by performing illumination compensation on the first prediction value based on the reconstructed sample mode for the current block.

In some embodiments, determining the reconstructed sample mode for the current block comprises: for an i^{th} candidate mode in the N candidate modes, determining a cost corresponding to the i^{th} candidate mode, wherein i is a positive integer and 1≤i≤N; and determining the reconstructed sample mode for the current block from the N candidate modes according to costs corresponding to the N candidate modes.

In some embodiments, determining the cost corresponding to the i^{th} candidate mode comprises: determining an i^{th} neighbouring reconstructed sample of the current block and an i^{th} neighbouring reconstructed sample of a reference block according to the i^{th} candidate mode; determining an i^{th} linear transform parameter according to the i^{th} neighbouring reconstructed sample of the current block and the i^{th} neighbouring reconstructed sample of the reference block; determining the first prediction value of the current block, and performing linear transformation on the first prediction value according to the i^{th} linear transform parameter to obtain a second prediction value corresponding to the i^{th} candidate mode; and determining the cost corresponding to the i^{th} candidate mode according to the second prediction value corresponding to the i^{th} candidate mode.

In some embodiments, determining the i^{th} neighbouring reconstructed sample of the current block and the i^{th} neighbouring reconstructed sample of the reference block according to the i^{th} candidate mode comprises: when the i^{th} candidate mode is the left reconstructed sample mode, determining the i^{th} neighbouring reconstructed sample of the current block according to a left neighbouring sample of the current block, and determining an i^{th} neighbouring reconstructed sample of a reference block corresponding to the current block in a reference picture according to a left neighbouring sample of the reference block.

In some embodiments, determining the i^{th} neighbouring reconstructed sample of the current block according to the left neighbouring sample of the current block comprises: determining the i^{th} neighbouring reconstructed sample of the current block according to a height of the current block and the left neighbouring sample of the current block.

In some embodiments, determining the i^{th} neighbouring reconstructed sample of the current block according to the height of the current block and the left neighbouring sample of the current block comprises: when the height of the current block is equal to a first value, selecting samples, the number of which is the first value, from the left neighbouring samples of the current block as the i^{th} neighbouring reconstructed sample of the current block.

In some embodiments, determining the i^{th} neighbouring reconstructed sample of the current block according to the height of the current block and the left neighbouring sample of the current block comprises: when the height of the current block is not equal to a first value, selecting samples, the number of which is a second value, from the left neighbouring samples of the current block as the i^{th} neighbouring reconstructed sample of the current block.

In some embodiments, determining the i^{th} neighbouring reconstructed sample of the reference block corresponding to the current block in the reference picture according to the left neighbouring sample of the reference block comprises: determining the i^{th} neighbouring reconstructed sample of the reference block according to a height of the reference block and the left neighbouring sample of the reference block.

In some embodiments, determining the i^{th} neighbouring reconstructed sample of the reference block according to the height of the reference block and the left neighbouring sample of the reference block comprises: when the height of the reference block is equal to a first value, performing interpolation on the left neighbouring samples of the reference block to obtain samples, the number of which is the first value, as the i^{th} neighbouring reconstructed sample of the reference block.

In some embodiments, determining the i^{th} neighbouring reconstructed sample of the reference block according to the height of the reference block and the left neighbouring sample of the reference block comprises: when the height of the reference block is not equal to a first value, performing interpolation on the left neighbouring samples of the reference block to obtain samples, the number of which is a second value, as the i^{th} neighbouring reconstructed sample of the reference block.

In some embodiments, determining the i^{th} neighbouring reconstructed sample of the current block and the i^{th} neighbouring reconstructed sample of the reference block according to the i^{th} candidate mode comprises: when the i^{th} candidate mode is the top reconstructed sample mode, determining the i^{th} neighbouring reconstructed sample of the current block according to a top neighbouring sample of the current block, and determining an i^{th} neighbouring reconstructed sample of a reference block corresponding to the current block in a reference picture according to a top neighbouring sample of the reference block.

In some embodiments, determining the i^{th} neighbouring reconstructed sample of the current block according to the top neighbouring sample of the current block comprises: determining the i^{th} neighbouring reconstructed sample of the current block according to a width of the current block and the top neighbouring sample of the current block.

In some embodiments, determining the i^{th} neighbouring reconstructed sample of the current block according to the width of the current block and the top neighbouring sample of the current block comprises: when the width of the current block is equal to a first value, selecting samples, the number of which is the first value, from the top neighbouring samples of the current block as the i^{th} neighbouring reconstructed sample of the current block.

In some embodiments, determining the i^{th} neighbouring reconstructed sample of the current block according to the width of the current block and the top neighbouring sample of the current block comprises: when the width of the current block is not equal to a first value, selecting samples, the number of which is a second value, from the top neighbouring samples of the current block as the i^{th} neighbouring reconstructed sample of the current block.

In some embodiments, determining the i^{th} neighbouring reconstructed sample of the reference block corresponding to the current block in the reference picture according to the top neighbouring sample of the reference block comprises: determining the i^{th} neighbouring reconstructed sample of the reference block according to a width of the reference block and the top neighbouring sample of the reference block.

In some embodiments, determining the i^{th} neighbouring reconstructed sample of the reference block according to the width of the reference block and the top neighbouring sample of the reference block comprises: when the width of the reference block is equal to a first value, performing interpolation on the top neighbouring samples of the reference block to obtain samples, the number of which is the first value, as the i^{th} neighbouring reconstructed sample of the reference block.

In some embodiments, determining the i^{th} neighbouring reconstructed sample of the reference block according to the width of the reference block and the top neighbouring sample of the reference block comprises: when the width of the reference block is not equal to a first value, performing interpolation on the top neighbouring samples of the reference block to obtain samples, the number of which is a second value, as the i^{th} neighbouring reconstructed sample of the reference block.

In some embodiments, the i^{th} linear transform parameter comprises an i^{th} scaling factor and an i^{th} offset parameter, and determining the i^{th} linear transform parameter according to the i^{th} neighbouring reconstructed sample of the current block and the i^{th} neighbouring reconstructed sample of the reference block comprises: determining the i^{th} scaling factor according to the i^{th} neighbouring reconstructed sample of the current block and the i^{th} neighbouring reconstructed sample of the reference block; and determining the i^{th} offset parameter according to the i^{th} neighbouring reconstructed sample of the current block, the i^{th} neighbouring reconstructed sample of the reference block, and the i^{th} scaling factor.

In some embodiments, performing linear transformation on the first prediction value according to the i^{th} linear transform parameter to obtain the second prediction value corresponding to the i^{th} candidate mode comprises: performing linear transformation on the first prediction value according to the i^{th} scaling factor and the i^{th} offset parameter to obtain the second prediction value corresponding to the i^{th} candidate mode.

In some embodiments, performing linear transformation on the first prediction value according to the i^{th} scaling factor and the i^{th} offset parameter to obtain the second prediction value corresponding to the i^{th} candidate mode comprises: determining a product of the i^{th} scaling factor and the first prediction value; and determining a sum of the product and the i^{th} offset parameter as the second prediction value corresponding to the i^{th} candidate mode.

In some embodiments, the determining the cost corresponding to the i^{th} candidate mode according to the second prediction value corresponding to the i^{th} candidate mode comprises: determining the cost corresponding to the i^{th} candidate mode according to the second prediction value corresponding to the i^{th} candidate mode and the current block.

In some embodiments, determining the reconstructed sample mode for the current block from the N candidate modes according to the costs corresponding to the N candidate modes comprises: determining a candidate mode with a minimum cost among the N candidate modes as the reconstructed sample mode for the current block.

In some embodiments, determining the second prediction value of the current block according to the reconstructed sample mode for the current block comprises: determining a second prediction value corresponding to the reconstructed sample mode for the current block as the second prediction value of the current block.

In some embodiment, the method further comprises: signalling a first index into a bitstream, wherein the first index indicates the reconstructed sample mode for the current block.

In some embodiments, when a prediction mode for the current block is a Merge mode, determining the reconstructed sample mode for the current block comprises: determining a first flag of a neighbouring block of the current block, wherein the first flag of the neighbouring block indicates whether the neighbouring block uses an illumination compensation technology; and determining the reconstructed sample mode for the current block according to the first flag of the neighbouring block.

In some embodiments, determining the reconstructed sample mode for the current block according to the first flag of the neighbouring block comprises: determining that the reconstructed sample mode for the current block is the top-and-left reconstructed sample mode, when the first flag of the neighbouring block indicates that the neighbouring block uses the illumination compensation technology.

In some embodiments, determining the reconstructed sample mode for the current block according to the first flag of the neighbouring block comprises: determining a reconstructed sample mode for the neighbouring block when the first flag of the neighbouring block indicates that the neighbouring block uses the illumination compensation technology; and determining the reconstructed sample mode for the neighbouring block as the reconstructed sample mode for the current block.

In some embodiments, determining the reconstructed sample mode for the neighbouring block comprises: determining a second index, wherein the second index indicates the reconstructed sample mode for the neighbouring block; and determining the reconstructed sample mode for the neighbouring block according to the second index.

In some embodiments, determining the second prediction value of the current block according to the reconstructed sample mode for the current block comprises: determining a neighbouring reconstructed sample of the current block and a neighbouring reconstructed sample of a reference block according to the reconstructed sample mode for the current block; and determining a linear transform parameter according to the neighbouring reconstructed sample of the current block and the neighbouring reconstructed sample of the reference block, and performing linear transformation on the first prediction value according to the linear transform parameter to obtain the second prediction value of the current block.

In some embodiments, the method further comprises: determining a first flag of the current block, and signalling the first flag into a bitstream, wherein the first flag of the current block indicates whether the current block uses an illumination compensation technology.

In some embodiments, the method further comprises: when the first flag of the current block indicates that the current block uses the illumination compensation technology, determining a second flag of the current block, and signalling the second flag of the current block into the bitstream, wherein the second flag of the current block indicates whether the current block uses an extended illumination compensation technology.

In some embodiments, the method further comprises: signalling an index of the reconstructed sample mode for the current block into the bitstream when the second flag of the current block indicates that the current block uses the extended illumination compensation technology.

In some embodiments, when a prediction mode for the current block is a Merge mode, determining the first flag of the current block comprises: determining a first flag of a neighbouring block of the current block, wherein the first flag of the neighbouring block indicates whether the neighbouring block uses the illumination compensation technology; and determining the first flag of the current block according to the first flag of the neighbouring block.

In some embodiments, when the prediction mode for the current block is the Merge mode, determining a second flag of the current block comprises: determining a second flag of the neighbouring block of the current block, wherein the second flag of the neighbouring block indicates whether the neighbouring block uses an extended illumination compensation technology; and determining the second flag of the current block according to the second flag of the neighbouring block.

In some embodiments, the first flag comprises at least one of: a sequence-level flag, a picture-level flag, or a block-level flag.

In some embodiments, determining the reconstructed sample mode for the current block comprises: determining the reconstructed sample mode for the current block when a current picture that the current block belongs to is a first-type picture.

In some embodiments, determining the reconstructed sample mode for current block comprises: determining the reconstructed sample mode for the current block when an area of the current block is greater than or equal to a preset threshold.

A video decoding apparatus, comprises: a decoding unit configured to decode a bitstream, and perform prediction on a current block to obtain a first prediction value; a mode determining unit configured to determine a reconstructed sample mode for the current block, wherein the reconstructed sample mode is one of N candidate modes, and the N candidate modes comprise at least one of a top reconstructed sample mode, a left reconstructed sample mode, or a top-and-left reconstructed sample mode; a sample determining unit configured to determine a neighbouring reconstructed sample of the current block and a neighbouring reconstructed sample of a reference block according to the reconstructed sample mode for the current block; and a linear transformation unit configured to determine a linear transform parameter according to the neighbouring reconstructed sample of the current block and the neighbouring reconstructed sample of the reference block, and perform linear transformation on the first prediction value according to the linear transform parameter to obtain a second prediction value of the current block.

A video encoding apparatus, comprises: a predicting unit configured to perform prediction on a current block to obtain a first prediction value of the current block; a mode determining unit configured to determine a reconstructed sample mode for the current block, wherein the reconstructed sample mode is one of N candidate modes, and the N candidate modes comprise at least one of a top reconstructed sample mode, a left reconstructed sample mode, or a top-and-left reconstructed sample mode; and a linear transformation unit configured to determine a second prediction value of the current block according to the reconstructed sample mode for the current block, wherein the second prediction value is obtained by performing illumination compensation on the first prediction value based on the reconstructed sample mode for the current block.

A video coding system, comprises: a video decoder configured to perform the above video decoding method; and a video encoder configured to perform the above video encoding method.

An electronic device, comprises: a memory configured to store computers programs; and a processor configured to execute the computer programs to implement the above video decoding method or the above video encoding method.

A computer-readable storage medium, configured to store computer executable instructions which, when executed by a processor, are operable to implement the above video decoding method or the above video encoding method.

A bitstream, comprises a bitstream obtained according to the above video decoding method or the above video encoding method.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

I/We claim:

1. A video decoding method, comprising:
decoding a bitstream, and performing prediction on a current block to obtain a first prediction value;
determining a reconstructed sample mode for the current block, wherein the reconstructed sample mode is one of N candidate modes, and the N candidate modes comprise at least one of a top reconstructed sample mode, a left reconstructed sample mode, or a top-and-left reconstructed sample mode;
determining a neighbouring reconstructed sample of the current block and a neighbouring reconstructed sample of a reference block according to the reconstructed sample mode for the current block; and
determining a linear transform parameter according to the neighbouring reconstructed sample of the current block and the neighbouring reconstructed sample of the reference block, and performing linear transformation on the first prediction value according to the linear transform parameter to obtain a second prediction value of the current block.

2. The method of claim 1, wherein determining the reconstructed sample mode for the current block comprises:
determining a first index, wherein the first index indicates the reconstructed sample mode for the current block; and
determining the reconstructed sample mode for the current block according to the first index.

3. The method of claim 2, wherein determining the first index comprises:
obtaining the first index by decoding the bitstream.

4. The method of claim 2, wherein when a prediction mode for the current block is a Merge mode, determining the first index comprises:
determining a first flag of a neighbouring block of the current block, wherein the first flag of the neighbouring block indicates whether the neighbouring block uses an illumination compensation technology; and
determining the first index according to the first flag of the neighbouring block.

5. The method of claim 4, wherein determining the first index according to the first flag of the neighbouring block comprises:
determining the first index to be a default index, when the first flag of the neighbouring block indicates that the neighbouring block uses the illumination compensation technology, wherein the default index indicates the top-and-left reconstructed sample mode.

6. The method of claim 4, wherein determining the first index according to the first flag of the neighbouring block comprises:
determining a second index when the first flag of the neighbouring block indicates that the neighbouring block uses the illumination compensation technology, wherein the second index indicates a reconstructed sample mode for the neighbouring block; and
determining the second index as the first index.

7. The method of claim 2, wherein when a prediction mode for the current block is a non-Merge mode, determining the first index comprises:
determining a first flag of the current block, wherein the first flag of the current block indicates whether the current block uses an illumination compensation technology;
determining a second flag of the current block when the first flag of the current block indicates that the current block uses the illumination compensation technology, wherein the second flag of the current block indicates whether the current block uses an extended illumination compensation technology; and
determining the first index according to the second flag of the current block.

8. The method of claim 7, wherein determining the first index according to the second flag of the current block comprises:
obtaining the first index by decoding the bitstream, when the second flag of the current block indicates that the current block uses the extended illumination compensation technology.

9. The method of claim 7, wherein determining the first index according to the second flag of the current block comprises:
determining the first index to be a default index, when the second flag of the current block indicates that the current block does not use the extended illumination compensation technology, wherein the default index indicates the top-and-left reconstructed sample mode.

10. The method of claim 1, wherein determining the neighbouring reconstructed sample of the current block and the neighbouring reconstructed sample of the reference block according to the reconstructed sample mode for the current block comprises:
when the reconstructed sample mode for the current block is the top reconstructed sample mode, determining the neighbouring reconstructed sample of the current block according to a top neighbouring sample of the current block, and determining a neighbouring reconstructed sample of a reference block corresponding to the current block in a reference picture according to a top neighbouring sample of the reference block.

11. The method of claim 10, wherein determining the neighbouring reconstructed sample of the current block according to the top neighbouring sample of the current block comprises:
determining the neighbouring reconstructed sample of the current block according to a width of the current block and the top neighbouring sample of the current block.

12. The method of claim 10, wherein determining the neighbouring reconstructed sample of the reference block corresponding to the current block in the reference picture according to the top neighbouring sample of the reference block comprises:
determining the neighbouring reconstructed sample of the reference block according to a width of the reference block and the top neighbouring sample of the reference block.

13. The method of claim 1, wherein the linear transform parameter comprises a scaling factor and an offset parameter, and determining the linear transform parameter according to the neighbouring reconstructed sample of the current block and the neighbouring reconstructed sample of the reference block comprises:
determining the scaling factor according to the neighbouring reconstructed sample of the current block and the neighbouring reconstructed sample of the reference block; and
determining the offset parameter according to the neighbouring reconstructed sample of the current block, the neighbouring reconstructed sample of the reference block, and the scaling factor;
wherein performing linear transformation on the first prediction value according to the linear transform parameter to obtain the second prediction value of the current block comprises: performing linear transformation on the first prediction value according to the scaling factor and the offset parameter, to obtain the second prediction value of the current block.

14. A video encoding method, comprising:
performing prediction on a current block to obtain a first prediction value of the current block;
determining a reconstructed sample mode for the current block, wherein the reconstructed sample mode is one of N candidate modes, and the N candidate modes comprise at least one of a top reconstructed sample mode, a left reconstructed sample mode, or a top-and-left reconstructed sample mode; and
determining a second prediction value of the current block according to the reconstructed sample mode for the current block, wherein the second prediction value is obtained by performing illumination compensation on the first prediction value based on the reconstructed sample mode for the current block.

15. The method of claim 14, wherein determining the reconstructed sample mode for the current block comprises:
for an i^{th} candidate mode in the N candidate modes, determining a cost corresponding to the i^{th} candidate mode, wherein i is a positive integer and 1≤i≤N; and
determining the reconstructed sample mode for the current block from the N candidate modes according to costs corresponding to the N candidate modes.

16. The method of claim 15, wherein determining the cost corresponding to the Ah candidate mode comprises:
determining an i^{th} neighbouring reconstructed sample of the current block and an i^{th} neighbouring reconstructed sample of a reference block according to the i^{th} candidate mode;
determining an i^{th} linear transform parameter according to the i^{th} neighbouring reconstructed sample of the current block and the i^{th} neighbouring reconstructed sample of the reference block;
determining the first prediction value of the current block, and performing linear transformation on the first prediction value according to the i^{th} linear transform parameter to obtain a second prediction value corresponding to the i^{th} candidate mode; and
determining the cost corresponding to the i^{th} candidate mode according to the second prediction value corresponding to the i^{th} candidate mode.

17. The method of claim 16, wherein the i^{th} linear transform parameter comprises an i^{th} scaling factor and an i^{th} offset parameter, and determining the i^{th} linear transform parameter according to the i^{th} neighbouring reconstructed sample of the current block and the i^{th} neighbouring reconstructed sample of the reference block comprises:
determining the i^{th} scaling factor according to the i^{th} neighbouring reconstructed sample of the current block and the i^{th} neighbouring reconstructed sample of the reference block; and
determining the i^{th} offset parameter according to the i^{th} neighbouring reconstructed sample of the current block, the i^{th} neighbouring reconstructed sample of the reference block, and the i^{th} scaling factor;
wherein performing linear transformation on the first prediction value according to the i^{th} linear transform parameter to obtain the second prediction value corresponding to the i^{th} candidate mode comprises: performing linear transformation on the first prediction value according to the i^{th} scaling factor and the i^{th} offset parameter to obtain the second prediction value corresponding to the i^{th} candidate mode.

18. The method of claim 15, wherein determining the reconstructed sample mode for the current block from the N candidate modes according to the costs corresponding to the N candidate modes comprises:
determining a candidate mode with a minimum cost among the N candidate modes as the reconstructed sample mode for the current block.

19. The method of claim 15, further comprising:
signalling a first index into a bitstream, wherein the first index indicates the reconstructed sample mode for the current block.

20. A non-transitory computer storage medium storing a bitstream generated according to an encoding method, wherein the encoding method comprises:
performing prediction on a current block to obtain a first prediction value of the current block;
determining a reconstructed sample mode for the current block, wherein the reconstructed sample mode is one of N candidate modes, and the N candidate modes comprise at least one of a top reconstructed sample mode, a left reconstructed sample mode, or a top-and-left reconstructed sample mode; and
determining a second prediction value of the current block according to the reconstructed sample mode for the current block, wherein the second prediction value is obtained by performing illumination compensation on the first prediction value based on the reconstructed sample mode for the current block.
